(19) United States
(12) Patent Application Publication
(10) Pub. No.: US 2004/0205570 A1
(43) Pub. Date: Oct. 14, 2004

(54) Test assisting program and test assisting method

(75) Inventor: Masaki Tonomura, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/083,489

(22) Filed: Feb. 27, 2002

(30) Foreign Application Priority Data
Aug. 2, 2001 (JP) 2001-235318

(51) Int. Cl. G06F 15/00

(52) U.S. Cl. 715/513

(57) ABSTRACT

A test assisting program and a test assisting method are effective in reducing the time and effort required to enter operation inputs in authenticating operation of a server application, and for obtaining highly reliable test results. When a structured document is outputted from a server computer, attribute information of a data input area is acquired, and candidate data depending on the attribute information is generated. A processing description for enabling a document browsing device to carry out a process of displaying the candidate data and a process of entering the candidate data selected by an operation input into the data input area, is inserted in a structured document. The structured document with the processing description inserted therein is transferred to the document browsing device. Then, the document browsing device displays the candidate data when it displays the structured document. When desired candidate data is selected by the operation input, the selected candidate data is set in the data input area.

### BACKGROUND OF THE INVENTION

(1) Field of the Invention

The present invention relates to a test assisting program and a test assisting method for server applications, and more particularly to a test assisting program and a test assisting method for assisting in entering operation inputs from a client.

(2) Description of the Related Art

Presently, various services are available through networks because of widespread usage of intraoffice networks and wide-area networks. Most client computers that are available recently have a prepackaged WEB browser for WWW(World Wide Web). Therefore, if a server computer having a prepackaged program for providing WEB pages (hereinafter referred to as “WEB server”) is used to provide services, then client computers are not required to have special programs installed therein, allowing users to introduce systems with ease. Many efforts are being made to develop application programs (hereinafter referred to simply as “applications”) for professional use which are to be run on WEB servers. For example, systems which use Java servlets, ASPs(Active Server Pages), and JavaScript use a WEB browser as a screen program for clients.

When an application program for professional use which is to be run on WEB servers is developed, it is necessary to confirm that the developed application operates normally. On WEB servers, there is provided an input/output environment based on GUI(Graphical User Interface), usually using HTML(HyperText Markup Language). Generally, it is difficult to generate a test driver for applications which allow data to be inputted and outputted via GUI. Therefore, it has been customary to manually confirm the operation of such applications.

When the operation of an application is manually confirmed, however, errors are likely to occur in manually entering data based on specifications. In addition, since entered data in a manual test are not left after the test, the test cannot be verified after it has been conducted. For these reasons, it is difficult to keep the test results on a desired level of reliability.

Screen display programs frequently have a wide range of input items, and test patterns for them are very large. It is highly time-consuming and hence practically difficult to enter all the test patterns through manual actions.

Moreover, though a test needs to be repeated in authenticating the operation of an application, it is not efficient to manually repeat the same process of the test. The authenticating process is always subject to the possibility of oversights because a visual inspection is relied upon to determine which test results are the same as or different from those of a previous test.

The response of a screen is often measured by the operator using a stopwatch. Since the response is measured a plurality of times and the results are accumulated and analyzed by the operator, the process has imposed a burden on the operator. While it is possible to modify the screen display program to display a processing time, it is necessary to restore the modified part of the program after the measurement has been made. Modifying the program source after the test leaves elements of anxiety about the quality of the tested application due to possible modification errors.

As described above, applications for WEB servers are problematic in that since they basically return HTML documents to clients, there is difficulty producing a test driver for confirming the operation of applications for WEB servers, and hence it is difficult to automatize the testing process.

There is a product as a WEB browser having a function to record operations in a test and carrying out the recorded operations again. This WEB browser is, however, a unique one different from the WEB browser that is in general use. In actual use, the WEB browser may possibly operate in a manner different from its operations in a test.

### SUMMARY OF THE INVENTION

It is therefore an object of the present invention to provide a test assisting program and a test assisting method for reducing the time and effort required to enter operation inputs in authenticating the operation of a server application, and for obtaining highly reliable test results.

To achieve the above objects, there is provided a test assisting program for assisting in testing operation of a server computer which provides services using a structured document which can be browsed by a document browsing device. The test assisting program enables a computer to carry out a process comprising steps of acquiring attribute information of a data input area of the structured document upon reception of the structured document from the server computer, generating candidate data for data to be inputted into the data input area based on the attribute information of the data input area, inserting a processing description for enabling the document browsing device to carry out a process of displaying the candidate data and a process of entering the candidate data selected by an operation input into the data input area, in the structured document, and transferring the structured document with the processing description inserted therein to the document browsing device.

To achieve the above objects, there is also provided a test assisting method in a test assisting apparatus for assisting in testing operation of a server computer which provides services using a structured document which can be browsed by a document browsing device. The test assisting method comprises steps of acquiring attribute information of a data input area of the structured document upon reception of the structured document from the server computer, generating candidate data for data to be inputted into the data input area based on the attribute information of the data input area, inserting a processing description for enabling the document browsing device to carry out a process of displaying the candidate data and a process of entering the candidate data selected by an operation input into the data input area, in the structured document, and transferring the structured document with the processing description inserted therein to the document browsing device.

The above and other objects, features, and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram showing the principles of the present invention;

FIG. 2 is a view showing a system according to an embodiment of the present invention;

FIG. 3 is a block diagram of a hardware arrangement of a terminal device used in the embodiment of the present invention;

FIG. 4 is a functional block diagram of the system according to the embodiment of the present invention;

FIG. 5 is a view showing a displayed test assisting view by way of example;

FIG. 6 is a view showing the concept of a data input assisting process;

FIG. 7 is a diagram showing a view file;

FIG. 8 is a diagram showing a processing description for displaying a view for selecting input candidate data;

FIG. 9 is a flowchart of a sequence of an input assisting process;

FIG. 10 is a view showing the concept of an operation recording process;

FIG. 11 is a diagram showing a log file of recorded operation details;

FIG. 12 is a flowchart of a processing sequence of a test operation recording process;

FIG. 13 is a view showing the concept of a test rerunning process;

FIG. 14 is a view showing a displayed view with an object to be operated on being visually clearly indicated;

FIG. 15 is a diagram showing results of a test which is run by operation inputs;

FIG. 16 is a diagram showing results of a test which is rerun;

FIG. 17 is a diagram showing the concept of a process of comparing test results;

FIG. 18 is a flow chart of a former portion of a processing sequence of a test rerunning process;

FIG. 19 is a flow chart of a latter portion of the processing sequence of the test rerunning process;

FIG. 20 is a diagram showing the concept of a response measurement assisting process;

FIG. 21 is a flowchart of a sequence of a response measuring process;

FIG. 22 is a view showing a test assisting view before it is rendered translucent;

FIG. 23 is a view showing a test assisting view after it is rendered translucent;

FIGS. 24(A) and 24(B) are views showing an image change caused by rendering a test assisting view translucent, FIG. 24(A) showing an image before it is rendered translucent and FIG. 24(B) showing an image after it is rendered translucent; and

FIG. 25 is a flowchart of a sequence of a process of rendering a test assisting view translucent.

### DESCRIPTION OF THE PREFERRED EMBODIMENTS

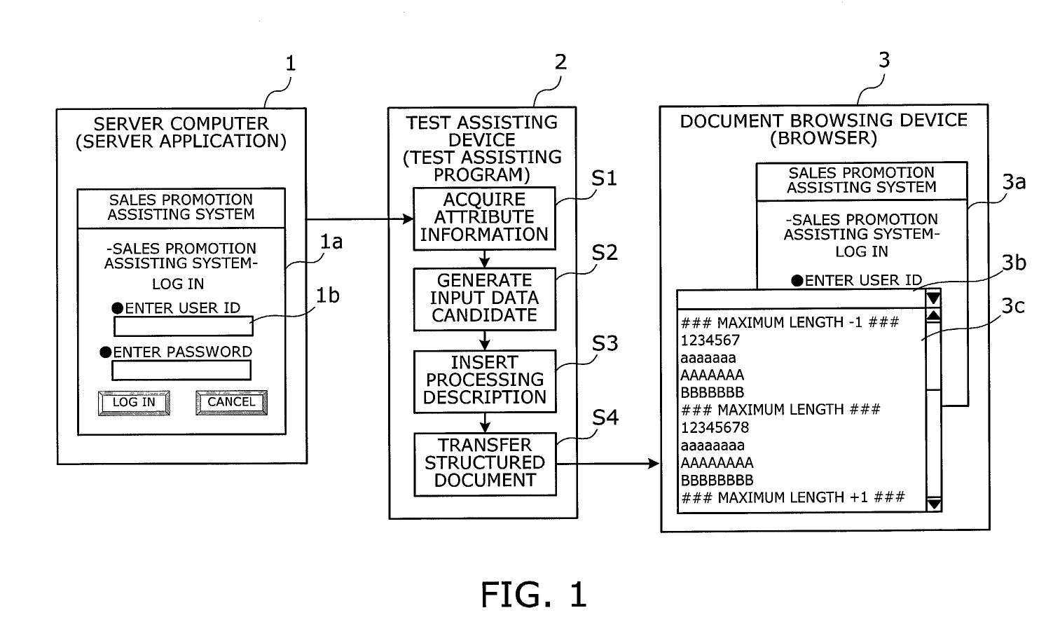

FIG. 1 shows the principles of the present invention. A test assisting program according to the present invention serves to assist in a test of the operation of a server computer 1 which provides services using a structured document that can be browsed by a document browsing device 3. The server computer 1 is a computer for providing a structured document to another computer by executing a server application program (server application), for example. The document browsing device 3 is a computer for browsing a structured document by executing a structured document browsing program (browser), for example. The structured document is a document written in HTML, for example.

The test assisting program is capable of having a computer carry out the processing which will be described below. A computer which executes the test assisting program according to the present invention functions as a test assisting device 2.

When the test assisting device 2 receives a structured document la from the server computer 1, the test assisting device 2 acquires attribute information of a data input area 1b of the structured document 1a (step S1). Then, the test assisting device 2 generates candidate data for data to be inputted in the data input area 1b based on the attribute information of the data input area 1b (step S2). The test assisting device 2 inserts a processing description for having the document browsing device 3 execute a process of displaying the candidate data and a process of inputting the candidate data selected by an operation input into the data input area 1b, in the structured document 1a (step S3). The test assisting device 2 then transfers a structured document 3a with the processing description inserted therein to the document browsing device 3 (step S4).

Therefore, when the server computer 1 outputs a structured document 1a, attribute information of the data input area 1b is acquired, and candidate data depending on the attribute information is generated. Then, a processing description for having the document browsing device 3 execute a process of displaying the generated candidate data and a process of inputting the candidate data selected by an operation input into the data input area 1b is inserted into the structured document 1a. The structured document 3a with the processing description inserted therein is transferred to the document browsing device 3. When the structured document 3a is displayed on the document browsing device 3, candidate data 3c are displayed. When desired candidate data is selected by an operation input, the selected candidate data is set in a data input area 3b.

According to the present invention, therefore, data to be inputted into the data input area 1b of the structured document 1a can be selected from the candidate data when the operation of the server computer 1 is tested. As a result, errors which may occur in inputting data into the data input area 1b can be reduced, reducing the burden imposed in a manual data inputting process in the test of the operation of the server computer 1, and increasing the reliability of the test results. This means that when the server computer 1 is operating according to a server application, the reliability of test results of an operation test for the server application is increased.

Since the inputting of data is assisted by inserting the processing description into the structured document, the functions of the document browsing device 3 are not required to be changed. The present invention is thus applicable even if the functions of the document browsing device 3 are provided by a general-purpose WEB browser. That is, the same WEB browser as used in actual operation can be used without the need for using a special WEB browser. Consequently, because displayed views and their operation remain unchanged when the server computer 1 is tested and when the server computer 1 is in actual operation, the quality of the server computer 1 can reliably be guaranteed.

While the function to assist in inputting test data has been described according to the principles of the present invention with reference to FIG. 1, the present invention is also applicable to various other test assisting processes such as for assisting in recording and rerunning test operations and also assisting in measuring responses. Embodiments of the present invention will be described in specific detail with respect to confirming the operation of a server application run on a WEB server using a test assisting apparatus equipped with these functions. In the embodiments described below, a program (test assisting program) containing processing details of a test assisting apparatus is installed in a client device (terminal device) to enable the terminal device to function as the test assisting apparatus.

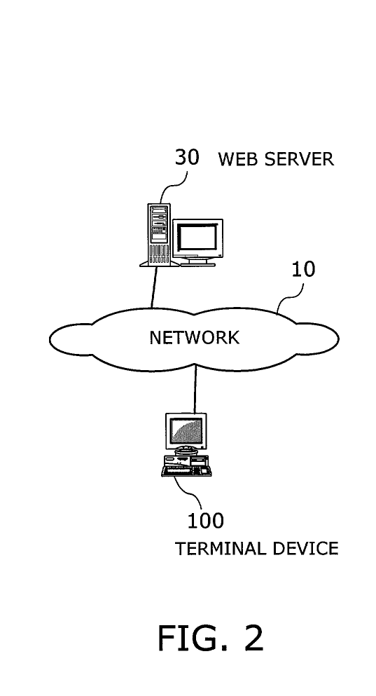

FIG. 2 shows a system according to an embodiment of the present invention. In the present embodiment, a WEB server 30 and a terminal device 100 are connected to each other by a network 10 which comprises a LAN(Local Area Network) or the Internet. The WEB server 30 is a WEB server with a prepackaged server application which is under development. The terminal device 100 has a WEB browser and a test assister installed therein. The test assister is a processing function that is achieved on the terminal device 100 when the terminal device 100 runs a test assisting program. The terminal device 100 comprises, for example, a personal computer or a portable information terminal referred to as PDA(Personal Digital Assistant).

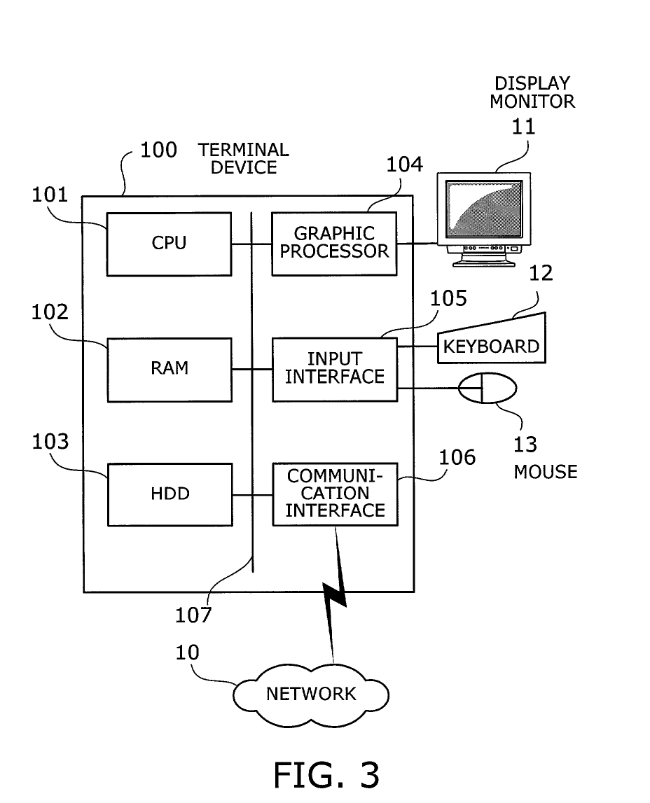

FIG. 3 shows in block form a hardware arrangement of the terminal device used in the embodiment of the present invention. As shown in FIG. 3, the terminal device 100 has a CPU(Central Processing Unit) 101 for controlling the terminal device in its entirety. To the CPU 101, there are connected a RAM(Random-Access Memory) 102, a hard disk drive(HDD) 103, a graphic processor 104, an input interface 105, and a communication interface 106 by a bus 107.

The RAM 102 temporarily stores the program of an OS(Operating System) and at least part of application programs that are run by the CPU 101. The RAM 102 also stores various data required for processing sequences performed by the CPU 101. The HDD 103 stores the OS and application programs.

A display monitor 11 is connected to the graphic processor 104. The graphic processor 104 displays images on the screen of the display monitor 11 according to instructions from the CPU 101. A keyboard 12 and a mouse 13 are connected to the input interface 105. The input interface 105 transmits signals from the keyboard 12 and the mouse 13 to the CPU 101 through the bus 107.

The communication interface 106 is connected to the network 10, which is a wide-area network such as the Internet. The communication interface 106 transmits data to and receives data from the WEB server 30 through the network 10.

The above hardware arrangement is capable of performing the processing functions according to the present embodiment. While the hardware arrangement of the terminal device 100 is shown in FIG. 3, the WEB server 30 has a similar hardware arrangement.

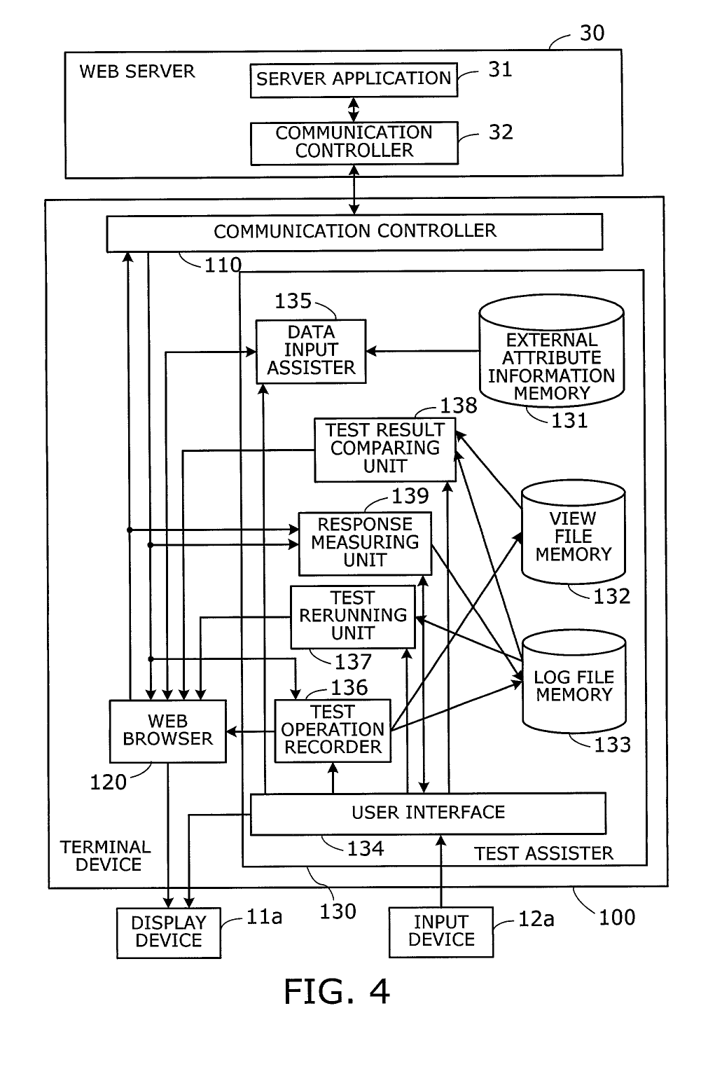

FIG. 4 shows the system according to an embodiment of the present invention in functional block form. As shown in FIG. 4, the WEB server 30 has a server application 31 and a communication controller 32.

The server application 31 provides services through the network 10 such as the Internet, using HTML documents. The server application 31 is a function that is achieved when the WEB server 30 executes a server application program whose operation is to be confirmed. The server application 31 is programmed with Java servlets, ASPs, and JavaScript, for example.

The communication controller 32 performs data communications with the terminal device 100 through the network 10 according to a communication protocol such as HTTP(HyperText Transfer Protocol).

To the terminal device 100, there are connected a display device 11a and an input device 12a. The display device 11a displays images outputted from the terminal device 100. Specifically, the display device 11a comprises the display monitor 11 shown in FIG. 3. The input device 12a receives an operation input from the test operator and inputs information depending on the operation input into the terminal device 100. Specifically, the input device 12a comprises functions of the keyboard 12 and the mouse 13 shown in FIG. 3.

The terminal device 100 has a communication controller 110, a WEB browser 120, and a test assister 130. The communication controller 110 performs data communications with the WEB server 30 through the network 10 according to a communication protocol such as HTTP.

The WEB browser 120 has a function to browse HTML documents. Specifically, the WEB browser 120 analyzes details of an HTML document and generates an image according to the HTML document. The image generated by the WEB browser 120 is displayed on the screen of the display device 11a. The WEB browser 120 receives input information from the input device 12a through the test assister 130, and transmits an execution request to execute a process based on the input information through the communication controller 110 to the server application 31. The WEB browser 120 receives a result of the execution request in the form of an HTML document through the test assister 130.

The WEB browser 120 is not specially generated for the purpose of confirming the operation of the server application 31. Rather, the WEB browser 120 is a general browser for browsing a wide variety of WEB pages on various WEB servers on the Internet.

The test assister 130 has an external attribute information memory 131, a view file memory 132, a log file memory 133, a user interface 134, a data input assister 135, a test operation recorder 136, a test rerunning unit 137, a test result comparing unit 138, and a response measuring unit 139.

The external attribute information memory 131 stores the attribute information of an input field in an HTML document transmitted from the server application 31, in association with the HTML document. The attribute information of an input field is stored in the external attribute information memory 131 by the developer of the server application 31 before the operation of the server application 31 is confirmed.

The view file memory 132 stores a view file in an HTML format transmitted from the server application 31. The view file is stored in the view file memory 132 by the test operation recorder 136.

The log file memory 133 stores a test pattern designated by an operation input from the test operator as a log file. The log file is generated by the test operation recorder 136 and stored in the log file memory 133.

The user interface 134 outputs image information of a test assisting view to the display device 11a to allow the display device 11a to display the test assisting view. The user interface 134 judges processing requests depending on input information entered from the input device 12a such as the keyboard 12, and outputs the processing requests to respective entities which are to execute processes represented by the processing requests.

When a control input is entered into the input device 12a for a view that is displayed on the display device 11a by the WEB browser 120, the user interface 134 acquires (intercepts) input information for the WEB browser 120. The user interface 134 then transfers the acquired input information to the test operation recorder 136.

The data input assister 135 acquires the view file which is being displayed by the WEB browser 120. The data input assister 135 refers to attribute information in the acquired view file or attribute information in the external attribute information memory 131, and judges attributes in the data input area in the view file. The data input assister 135 then inserts an input view for entering input candidate data for the data input area into the view file. The data input assister 135 transfers the view file in which the input view for entering input candidate data has been inserted to the WEB browser 120.

The test operation recorder 136 generates a log file from input information transferred from the user interface 134. The test operation recorder 136 transfers the input information to the WEB browser 120, and stores the generated log file in the log file memory 133. The test operation recorder 136 acquires a view file which is a result of the execution of an execution request issued from the WEB browser 120 to the server application 31, and stores the view file in the view file memory 132.

According to a processing request for rerunning a test from the user interface 134, the test rerunning unit 137 refers to a log file stored in the log file memory 133 and reproduces input information for the WEB browser 120. The test rerunning unit 137 transfers the reproduced input information to the WEB browser 120.

In response to a processing request from the user interface 134, the test result comparing unit 138 acquires a result of the execution of an execution request issued from the WEB browser 120 to the server application 31. Then, the test result comparing unit 138 acquires a result in the past of the execution of a similar execution request from the view file memory 132. The test result comparing unit 138 compares the result of the execution sent from the server application 31 with the result in the past of the execution acquired from the view file memory 132, and detects a difference. The test result comparing unit 138 makes a change to display the difference in highlight, in the result of the execution sent from the server application 31, and transfers the changed result of the execution to the WEB browser 120.

The response measuring unit 139 measures a response of the server application 31 in response to a processing request from the user interface 134. Specifically, the response measuring unit 139 detects that details of an input to the WEB browser 120 have been determined and that a result of the execution has been returned from the server application 31 to the WEB browser 120. The response measuring unit 139 measures a time from the determination of the details of the input to the reception of the result of the execution, and stores the measured time additionally in a corresponding log file in the log file memory 133.

With the above system thus arranged, the system operator is able to confirm the operation of the server application 31 using the WEB browser 120 while being assisted by the test assister 130.

Inputs can be made to the test assister 130 through a test assisting view provided by the user interface 134.

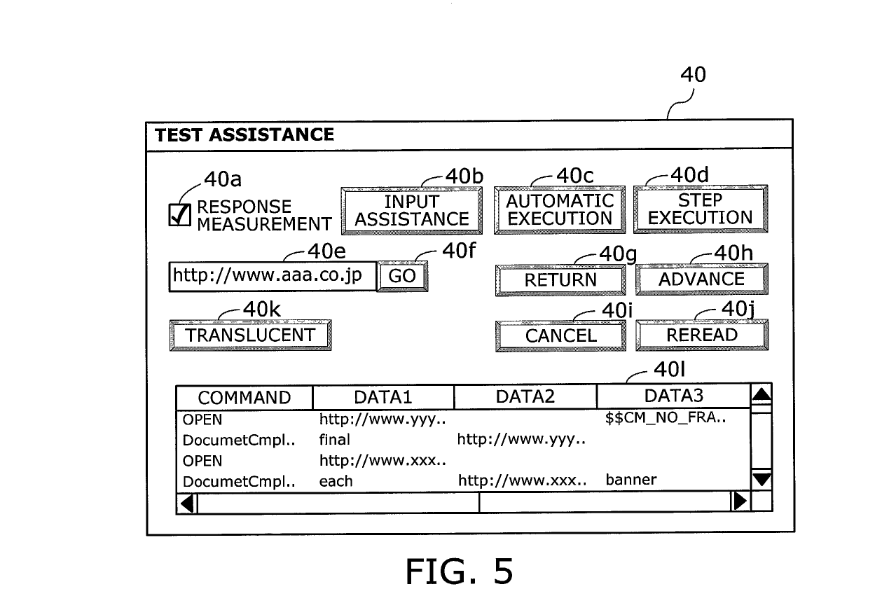

FIG. 5 shows a displayed test assisting view by way of example. As shown in FIG. 5, a test assisting view 40 has a response measurement check box 40a, an input assistance button 40b, an automatic execution button 40c, a step execution button 40d, a file location input area 40e, a GO button 40f, a return button 40g, an advance button 40h, a cancel button 40i, a reread button 40j, a translucent button 40k, and a log display view 40l.

The response measurement check box 40a is a check box for indicating whether a response measuring process is to be carried out or not. The response measurement check box 40a can be selected, i.e., with a check mark displayed, or unselected with no check mark displayed, by being clicked with the mouse. If the response measurement check box 40a is selected, then the response measuring unit 139 performs a response measuring process each time details inputted to the WEB browser 120 are determined and the WEB browser 120 outputs an execution request to the server application 31.

The input assistance button 40b is a button for carrying out an input assisting process. When the input assistance button 40b is pressed, the user interface 134 issues a processing request for carrying out an input assisting process to the data input assister 135, which then executes the input assisting process.

The automatic execution button 40c is a button for automatically rerunning a test. A test is automatically rerun by successively carrying out a series of processing steps recorded in a log file without requiring the test operator to enter operation inputs. When the automatic execution button 40c is pressed, the user interface 134 issues a processing request for automatic execution to the test rerunning unit 137, which automatically reruns a test.

The step execution button 40d is a button for rerunning a test step by step. A step is rerun step by step by executing a process according to one line of processing description recorded in a log file each time the step execution button 40d is pressed. When the step execution button 40d is pressed, the user interface 134 issues a processing request for step execution to the test rerunning unit 137, which reruns a test step by step.

The file location input area 40e is a text box for inputting the location of a view file in an HTML format which is provided by the server application 31.

The GO button 40f is a button for outputting a rowing request for browsing a view file in the location which is entered in the file location input area 40e. When the GO button 40f is pressed, a processing request for reading the pages of the view file in the location which is entered in the file location input area 40e is issued from the user interface 134 to the WEB browser 120. The communication controller 110 then transmits a page reading request for reading the pages of the view file from the WEB browser 120 to the server application 31, which then transmits the view file to the WEB browser 120.

The return button 40g is a button for displaying a view file which has been read immediately before. When the return button 40g is pressed, a page reading request for reading the pages of a view file which was displayed on the WEB browser 120 before the view file presently displayed on the WEB browser 120 is issued from the user interface 134 to the WEB browser 120. The communication controller 110 then transmits a page reading request for reading the pages of the previously displayed view file from the WEB browser 120 to the server application 31, which then transmits the view file to the WEB browser 120.

The advance button 40h is a button which, when a preceding view file is displayed by the return button 40g, displays a view file displayed following the preceding view file. When the advance button 40h is pressed, a page reading request for reading the pages of a view file which was displayed on the WEB browser 120 subsequently to the view file presently displayed on the WEB browser 120 is issued from the user interface 134 to the WEB browser 120. The communication controller 110 then transmits a page reading request for reading the pages of the subsequently displayed view file from the WEB browser 120 to the server application 31, which then transmits the view file to the WEB browser 120.

The cancel button 40i is a button for canceling the reading of a view file. When the cancel button 40i is pressed while a view file is being read, the user interface 134 issues a processing request for stopping the reading of the view file to the WEB browser 120, which stops the reading of the view file.

The reread button 40j is a button for rereading a view file which is being displayed on the WEB browser 120. When the reread button 40j is pressed, the user interface 134 issues a processing request for rereading a view file to the WEB browser 120. Then, the communication controller 110 transmits a page reading request for reading the pages of a view file which is being displayed to the server application 31, which sends the view file to the WEB browser 120.

The translucent button 40k is a button for rendering the test assisting view 40 translucent. When the translucent button 40k is pressed, the user interface 134 makes the test assisting view 40 translucent by combining and displaying the test assisting view 40 and an image which has been hidden behind the test assisting view 40.

The log display view 401 is a display area for displaying the details of operation inputs entered into the view of the WEB browser 120. Specifically, when an operation input is entered in the WEB browser 120, the user interface 134 transfers input information to the test operation recorder 136. The test operation recorder 136 generates and updates a log file, which is transferred to the user interface 134 that displays the details of the log file on the log display view 401.

When the test operator enters operation inputs in the test assisting view 40, the operation of the server application 31 can easily be tested.

Processing functions of the test assisting process carried out by the test assister 130 will be described below.

[Data Input Assistance]

First, a data input assisting process will be described below. In the data input assisting process, attributes (maximum value/minimum value, etc) of the data input area are judged from the attribute information stored in the external attribute information memory 131 or the attribute information embedded in a displayed view file in an HTML format. A list of input candidate data for the data input area is generated/displayed, and the view file is changed to allow data to be selected from the input candidate data and inputted to the data input area.

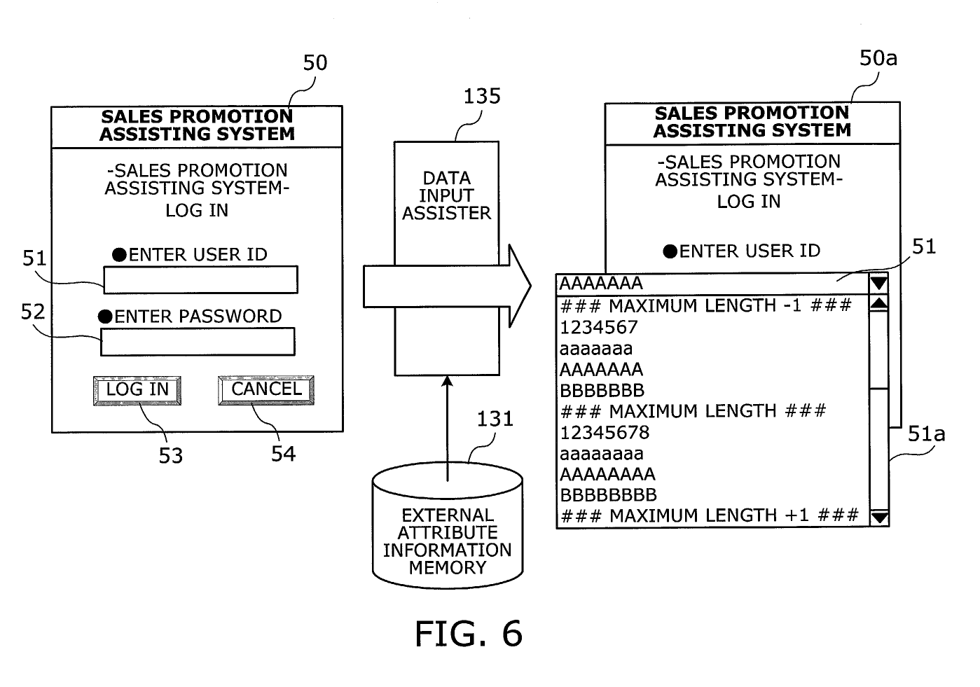

FIG. 6 shows the concept of the data input assisting process. FIG. 6 illustrates a displayed view 50 based on a view file transmitted from the server application 31 and a displayed view 50a based on a view file whose contents have been changed by the data input assister 135.

In FIG. 6, a log-in view of a sales promotion assisting system is illustrated as an example of the displayed view 50 transmitted from the server application 31. The displayed view 50 includes two data input areas 51, 52, a log-in button 53, and a cancel button 54. The data input area 51 is a text box for entering a user ID, and the data input area 52 is a text box for entering a password. The log-in button 53 is a button for transmitting an execution request for executing a user authenticating process based on data entered in the data input areas 51, 52 to the server application 31. The cancel button 54 is a button for erasing data entered in the data input areas 51, 52.

When the input assistance button 40b on the test assisting view 40 is pressed while the view 50 is being displayed by the WEB browser 120, the attribute information in the data input areas 51, 52 of the displayed view 50 is determined. The attribute information is determined selectively in an external definition information referring mode and an intra-view-page referring mode.

In the external definition information referring mode, the data input assister 135 refers to the external attribute information memory 131, and acquires attribute information corresponding to the view file which serves as a source for generating the view 50.

In the intra-view-page referring mode, the data input assister 135 acquires attribute information in the view file which serves as a source for generating the view 50. For example, the data input assister 135 acquires, as attribute information, the maximum length of inputted characters, and attributes of characters that can be inputted (equations, characters, two-byte codes, one-byte codes, etc.).

Based on the acquired attribute information, the data input assister 135 generates input candidate data. For example, if the maximum length of inputted characters is 8 characters, then the data input assister 135 generates 7-character input candidate data (data matching the attribute information), 8-character input candidate data (data matching the attribute information), and 9-character input candidate data (data not matching the attribute information). A processing description for displaying a view for selecting input candidate data is added to the view file, which is then transferred to the WEB browser 120. The WEB browser 120 displays the view 50a after the contents have been changed.

The view 50a includes a pull-down menu 51a for selecting input candidate data. When the test operator selects one of the input candidate data from the pull-down menu 51a, the selected input candidate data is set in the data input area 51. In the example shown in FIG. 6, the input candidate data representing a character string “AAAAAAA” is selected and set in the data input area 51.

A specific example of a view file will be described below.

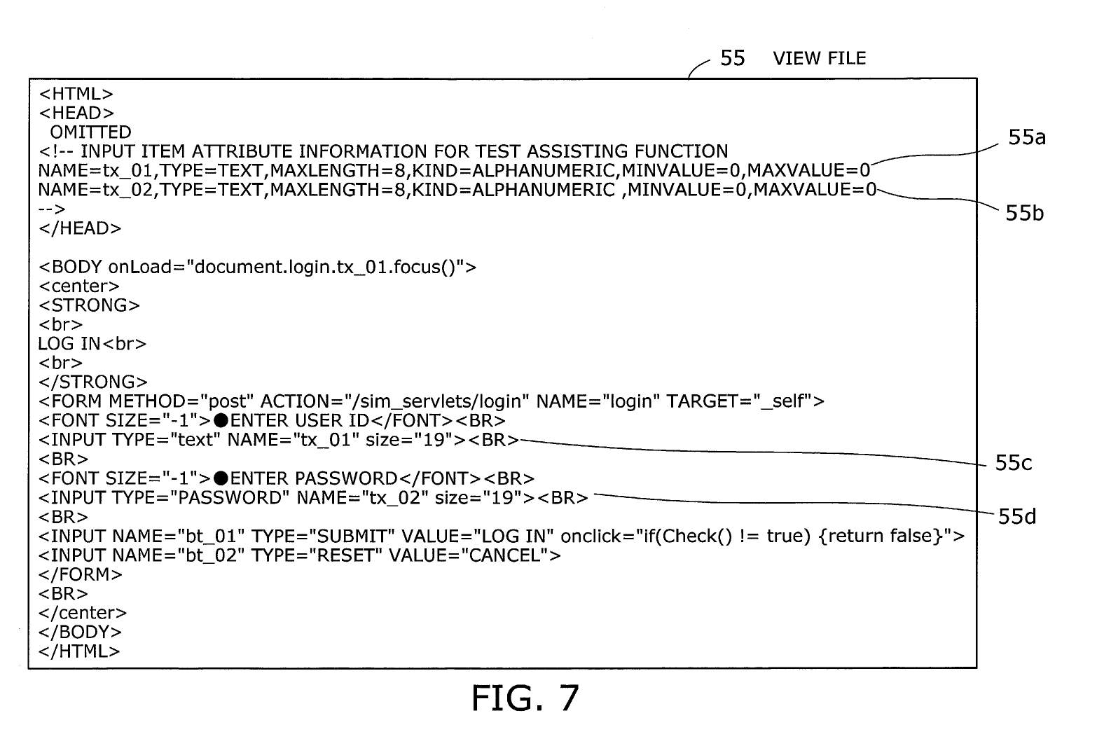

FIG. 7 shows a view file by way of example. A view file 55 shown in FIG. 7 is a file in an HTML format which serves as a source of the view 50 shown in FIG. 6. The view file 55 includes attribute information 55a, 55b of the data input areas 51, 52 and definition information 55c, 55d of the data input areas 51, 52.

The attribute information 55a with respect to the data input area 51 is defined in HEAD, i.e., an area between <HEAD> and </HEAD>. “NAME=tx_{—}01” indicates the title of the data input area 51. “TYPE=TEXT” indicates that a text can be entered. “MAXLENGTH=8” indicates that a maximum of 8 characters can be entered. “KIND=ALPHANUMERIC” indicates that alphanumeric characters can be entered. “MINVALUE=0” indicates a minimum value for entering a numerical value. In this example, this attribute is invalid because a text is entered. “MAXVALUE=0” indicates a maximum value for entering a numerical value. In this example, this attribute is also invalid because a text is entered.

Similarly, the attribute information 55b with respect to the data input area 52 is defined in the HEAD tag. The attribute information 55b is the same as the attribute information 55a except for “NAME=tx_{—}02” which indicates the title of the data input area 52.

The definition information 55c of the data input area 51 is defined by an INPUT tag. “TYPE=“text””indicates that a text is entered. “NAME=”tx_{—}01”” which indicates the title of the data input area 51. “size=“19”” indicates the horizontal width of the text box.

Similarly, the definition information 55d of the data input area 52 is defined by an INPUT tag. The definition information 55d is the same as the definition information 55c except for “NAME=“tx_{—}02”” which indicates the title of the data input area 52.

When the view file 55 is read by the WEB browser 120 and the input assistance button 40b in the test assisting view 40 is pressed, input candidate data corresponding to the data input areas 51, 52 are generated, and a processing description for displaying a view for selecting input candidate data is inserted into a line next to the definition information 55a, 55d.

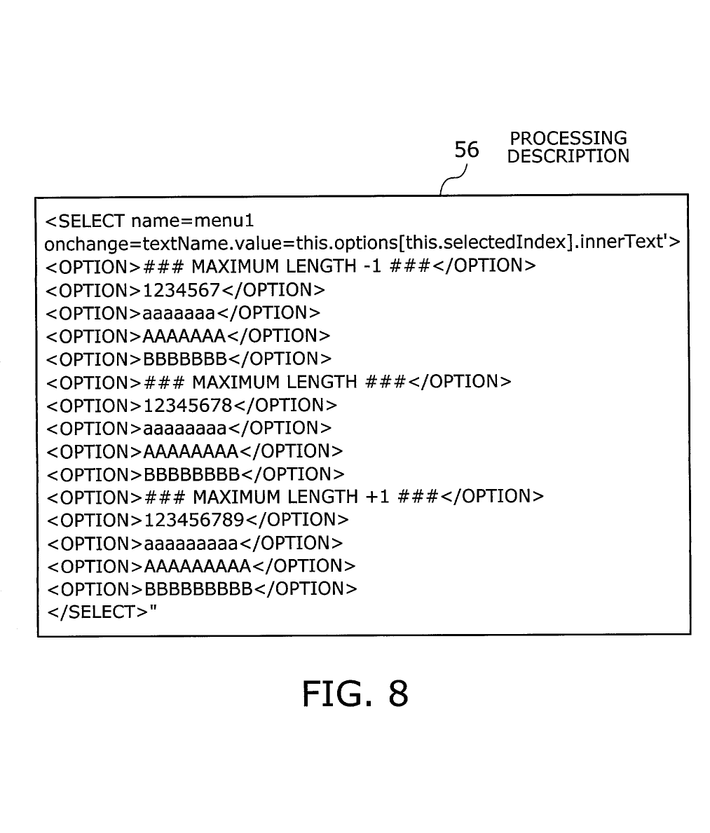

FIG. 8 shows a processing description for displaying a view for selecting input candidate data. As shown in FIG. 8, a processing description 56 is defined by a SELECT tag. In the SELECT tag, selected text data is set in the value of a given variable by a state change event (onChange). Input candidate data is defined by an OPTION tag.

When the processing description 56 is inserted next to the definition information 55c, 55d in the view file 55, a view file in an HTML format for displaying the view file 50a is generated.

A processing sequence of an input assisting process will be described below.

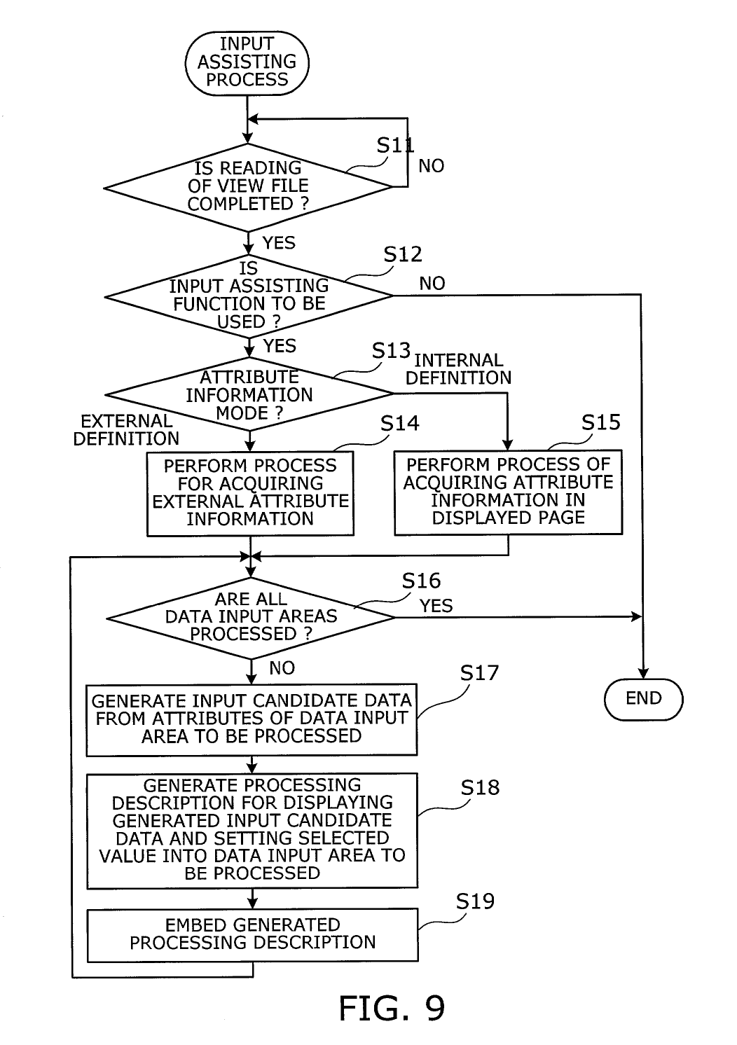

FIG. 9 shows a processing sequence of an input assisting process. The processing sequence shown in FIG. 9 will be described below according to step numbers shown therein. The processing sequence is executed each time a page readout request is issued from the WEB browser 120 to the server application 31.

[SETP S11] The data input assister 135 determines whether the reading of a view file by the WEB browser 120 is completed or not. If the reading of a view file is completed, then control goes to step S12. If not, then the processing in step S11 is repeated.

[STEP S12] The data input assister 135 determines whether an input assisting function is to be used or not based on whether the input assistance button 40b in the test assisting view 40 is pressed or not. If an input assisting function is to be used, then control goes to step S13. If an input assisting function is not to be used, then the processing sequence is put to an end.

[STEP S13] The data input assister 135 determines an attribute information mode. If the attribute information definition corresponding to the read view file is stored in the external attribute information memory 131, then the attribute information mode can be determined as an external definition mode, and if the attribute information definition corresponding to the read view file is not stored in the external attribute information memory 131, then the attribute information mode can be determined as an internal definition mode. Alternatively, if attribute definition information is included in the read view file, then the attribute information mode may be determined as an internal definition mode, and if attribute definition information is not included in the read view file, then the attribute information mode may be determined as an external definition mode.

If the attribute information mode is determined as an external definition mode, then control goes to step S14. If the attribute information mode is determined as an internal definition mode, then control goes to step S15.

[STEP S14] The data input assister 135 refers to the external attribute information memory 131, and acquires attribute definition information corresponding to the view file read by the WEB browser 120. Thereafter, control proceeds to step S16.

[STEP S15] The data input assister 135 searches the view file read by the WEB browser 120 and acquires attribute definition information.

[STEP S16] The data input assister 135 determines whether the processing in steps S17 through S19 has been carried out for all the data input areas or not. If the processing has been carried out for all the data input areas, then the data input assisting process is ended. If there is a data input area which has not been processed, then control goes to step S17.

[STEP S17] The data input assister 135 generates input candidate data based on the attributes of a data input area to be processed.

[STEP S18] The data input assister 135 generates a processing description for displaying the generated input candidate data and setting the selected input candidate data into the data input area.

[STEP S19] The data input assister 135 embeds the processing description in the view file such that the input candidate data according to the generated processing description will be displayed near the data input area to be processed.

In this manner, the input candidate data in the data input area can be displayed and the selected input candidate data can be set in the data input area when the operation of the server application 31 is to be tested. For example, for testing the attributes (the number of figure positions, a character type, etc.) of respective input items, data optimum for the test which include input candidate data matching the attributes and input candidate data not matching the attributes are generated, and a list of the data is displayed. Therefore, the test operator is not required to enter characters such as of text sentences, and is free of making input errors. Since test data are prevented from varying from test operator to test operator, the quality of tests is uniformized. The burden on the test operator for making inputs is reduced.

Because not only input candidate data matching the attributes but also input candidate data not matching the attributes are generated, an operation confirming process can easily be performed to confirm that an error occurs by intentionally entering wrong data.

[Recording of Test Operations]

A process of recording test operations will be described below. In the process of recording test operations, when an operation input to request the server application 31 to perform a process is entered into the document browsing device 3, the content of the operation input is determined, and a log file in which the determined content of the operation input is recorded is generated. The determination of the operation input means the determination of a location where data is entered or the determination of a button which is pressed. In the process of recording test operations, the content of the operation input is stored, and a view file acquired for the test is also recorded.

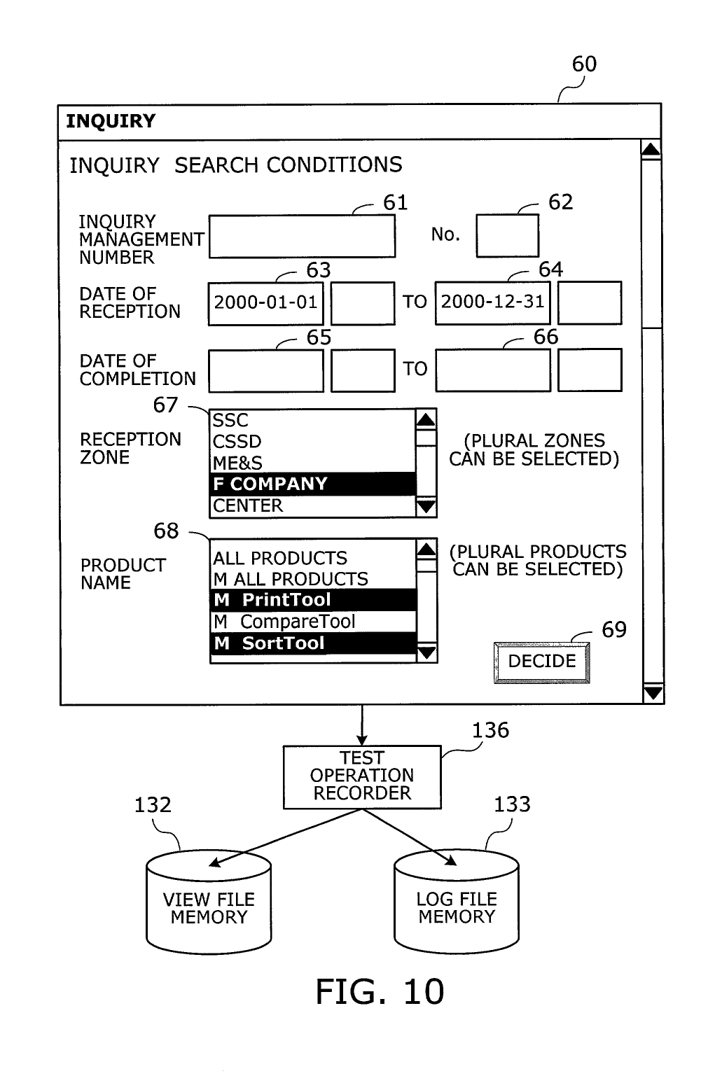

FIG. 10 shows the concept of an operation recording process. In the operation recording process, when the WEB browser 120 displays a view 60, a view file serving as a source of the view 60 is stored in the view file memory 132 by the test operation recorder 136. An operation input entered into the view 60 is acquired by the test operation recorder 136 and stored in the log file memory 133.

In the example shown in FIG. 10, the view 60 is shown for searching inquiry information from customers. The view 60 includes data input areas 61 through 66, data selecting windows 67, 78, and a decision button 69.

The data input area 61 is a text box for entering an inquiry management number. The data input area 62 is a text box for entering reference numbers assigned to a plurality of inquires for one inquiry management number. The data input area 63 is a text box for entering the starting date of a period to be searched in a search according to dates of reception. The data input area 64 is a text box for entering the ending date of a period to be searched in a search according to dates of reception. The data input area 66 is a text box for entering the starting date of a period to be searched in a search according to dates of completion. The data input area 65 is a text box for entering the ending date of a period to be searched in a search according to dates of completion. The data selecting window 67 is a selecting window for indicating a reception zone. The data selecting window 68 is a selecting window for selecting the name of a product to make an inquiry about. The decision button 69 is a button for outputting a processing request for carrying out a search to the server application 31.

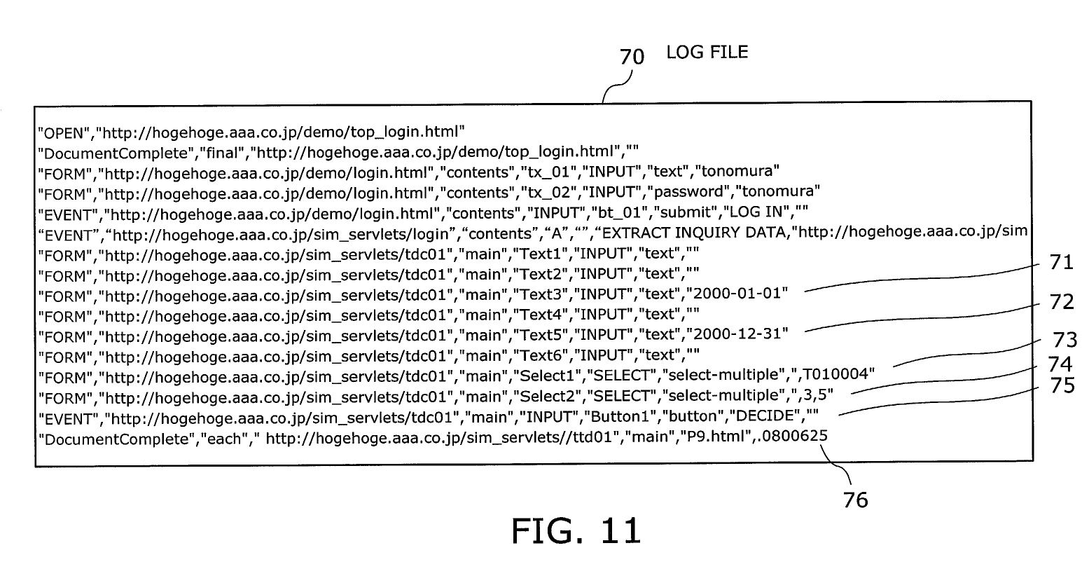

FIG. 11 shows a log file of recorded operation details. As shown in FIG. 11, a log file 70 contains recorded operation details from a log in to an operation input corresponding to the view 60 shown in FIG. 10.

In the log file 70, an operation description beginning with “OPEN” is registered when an operation input for acquiring a view file is entered. When the acquisition of a view file is completed, an associated description starting with “DcomentComplete”, i.e., a description of the location of a view file in the WEB server 30 and the view file memory 132 and a file name thereof, is registered. When data is inputted in the data input area, an operation description beginning with “FORM” is registered. When a button or link is pressed, an operation description beginning with “EVENT” is registered.

For example, an input operation in the data input area 63 is recorded as an operation description 71, and an input operation in the data input area 64 is recorded as an operation description 72. A selecting operation in the data selecting window 67 is recorded as an operation description 73, and a selecting operation in the data selecting window 68 is recorded as an operation description 74. A pressing operation of the decision button 69 is recorded as an operation description 75.

When a view file of a search result view is returned from the server application 31 in response to a search request outputted based on the view 60, a URL (http://hogehoge.aaa.co.jp/sim_servlets//ttd01) indicative of the location of the view file and its file name, and a frame name (main) and a file name (P9.html) of the view file stored in the view file memory 132 are recorded as an associated description 76.

When search conditions are entered in the view 60 and the decision button 69 is pressed, the WEB browser 120 issues a request for executing a search process to the server application 31, which then carries out the search process. Then, the server application 31 returns an HTML document representing a result of the search process which is carried out to the WEB browser 120, whereupon the view 60 for entering search conditions changes to a displayed view of the result of the search result.

A processing sequence of the test operation recording process will be described below.

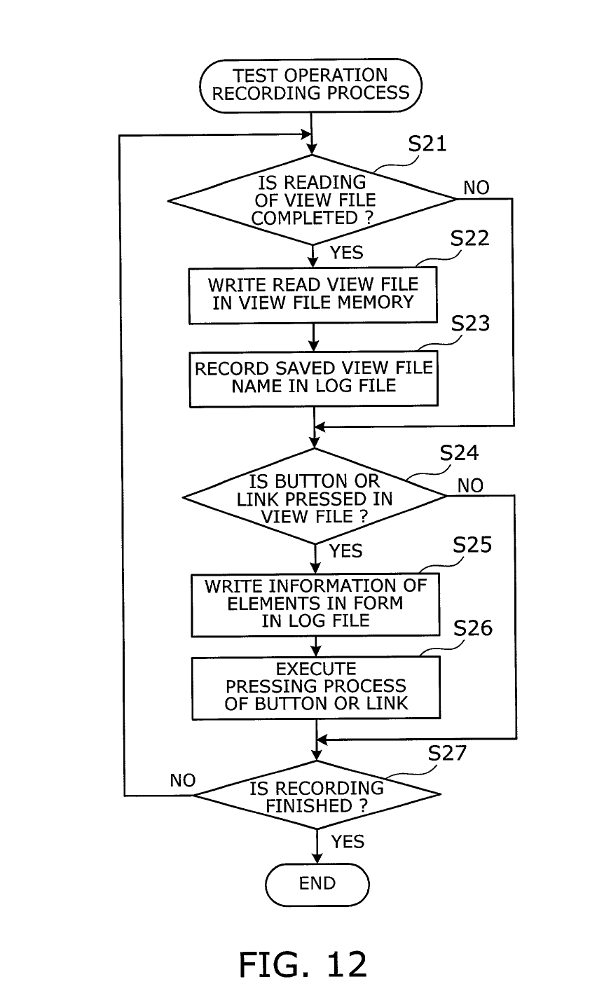

FIG. 12 shows a processing sequence of the test operation recording process. The processing sequence shown in FIG. 12 will be described below according to step numbers shown therein.

[STEP S21] The test operation recorder 136 determines whether the reading of a view file by the WEB browser 120 is completed or not. If the reading of a view file is completed, then control goes to step S22. If the reading of a view file is not completed, or if the read file has already been stored, then control goes to step S24.

[STEP S22] The test operation recorder 136 writes the read view file in the view file memory 132.

[STEP S23] The test operation recorder 136 records the file name of the saved view file in a log file.

[STEP S24] The test operation recorder 136 determines whether a button or a link (characters or an image linked to another view file) in the view file is pressed or not. If a button or a link is pressed, then control goes to step S25. If a button or a link is not pressed, then control goes to step S27.

[STEP S25] The test operation recorder 136 determines information entered in a form (data entered in a data input area such as a text box or data selected in a data selecting window), and writes an operation description indicative of the information in the log file.

[STEP S26] The test operation recorder 136 determines a pressed object (a button or a link), and carries out a pressing process of a button or a link with respect to the WEB browser 120. Specifically, since an operation input to be entered from the input device 12a into the WEB browser 120 is intercepted by the test operation recorder 136, the test operation recorder 136 executes the pressing process after the log file is updated. The details of the operation input are now transmitted to the WEB browser 120.

[STEP S27] The test operation recorder 136 determines whether the process has been finished or not. If the processing has been finished, then the test operation recording process is ended. If the processing has not been finished, then control goes back to step S21.

In this fashion, the details of test operations can be recorded. While test data cannot heretofore be recorded in a view and hence cannot be verified by the third party after the test, the above test operation recording process according to the present invention allows the third party to subsequently confirm the details of operation inputs that have been entered when the operation of the server application.

[Rerunning of a Test]

A process of rerunning a test will be described. In the process of rerunning a test, input data are automatically successively entered into a view file based on information recorded as a log file, a test is automatically carried out.

In the process of rerunning a test, a button and a link which are operated on can visually be clearly indicated, and the results of a rerun test and the results of a past test can be compared with each other for pointing out differences.

The process of rerunning a test is performed selectively in an automatic execution mode and a step execution mode. When the automatic execution button 40c is pressed, the test rerunning unit 137 automatically rerunning a test. In the automatic execution mode, the test is rerun continuously according to the description in the log file. When the step execution button 40d is pressed, the test rerunning unit 137 reruns the test step by step. Specifically, each time the step execution button 40d is pressed, the test is carried out in one event unit in the log file, e.g., upon pressing of a button or a link.

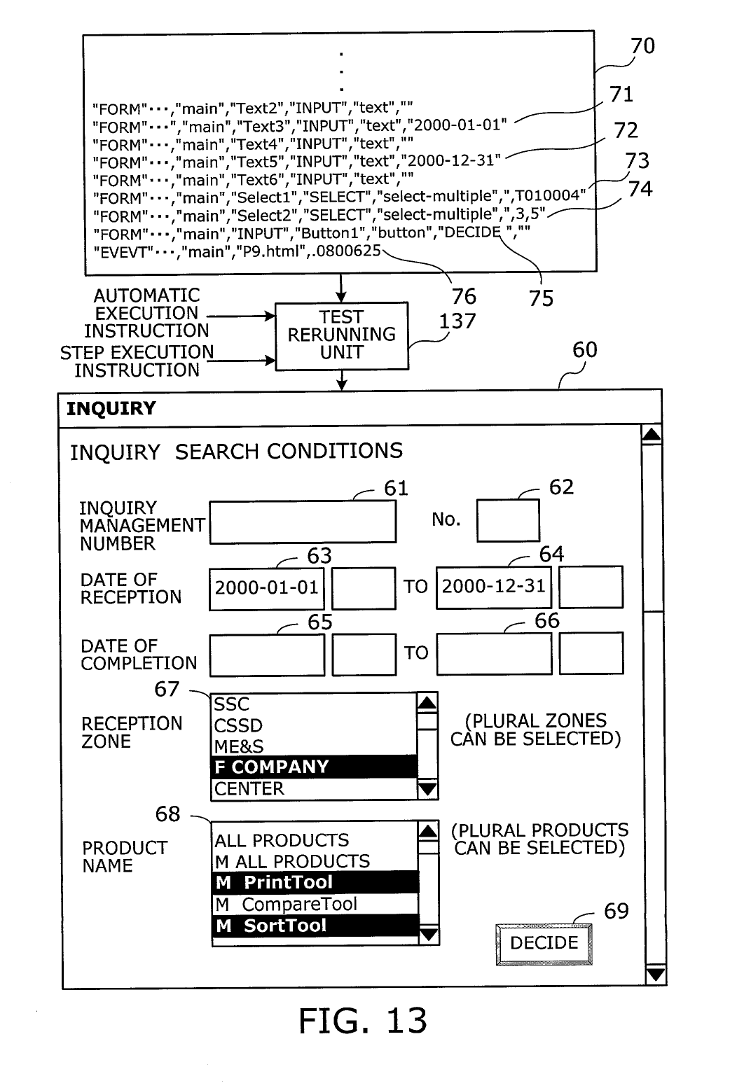

FIG. 13 shows the concept of the test rerunning process. The test rerunning unit 137 reads a log file 70 recorded in the test operation recording process from the log file memory 133, and reproduces the recorded details. If a line begins with “FORM”, then the test rerunning unit 137 sets data. If a line begins with “EVENT”, then the test rerunning unit 137 performs a pressing process of a button or a link.

For example, the test rerunning unit 137 reads the log file 70. If the automatic execution button 40c or the step execution button 40d is pressed, then the test rerunning unit 137 reads a view file which serves as a source of the view 60 with respect to the WEB browser 120 from the server application 31 based on the description in the log file 70, and displays the view 60. The test rerunning unit 137 enters data into the data input area 63 according to the operation description 71, enters data into the data input area 64 according to the operation description 72, selects data from the data selecting area 67 according to the operation description 73, and selects data from the data selecting area 68 according to the operation description 74. Finally, the test rerunning unit 137 performs a pressing process of the decision button 69 according to the operation description 75.

In the pressing process of a button or a link when the test is rerun, the object which is processed can visually be clearly indicated. Specifically, when the test is rerun based on the log file, the test rerunning unit 137 displays a button or a link to be operated on in visual highlight before the button or the link is pressed, thereby allowing the test operator to clearly confirm the object to be operated on.

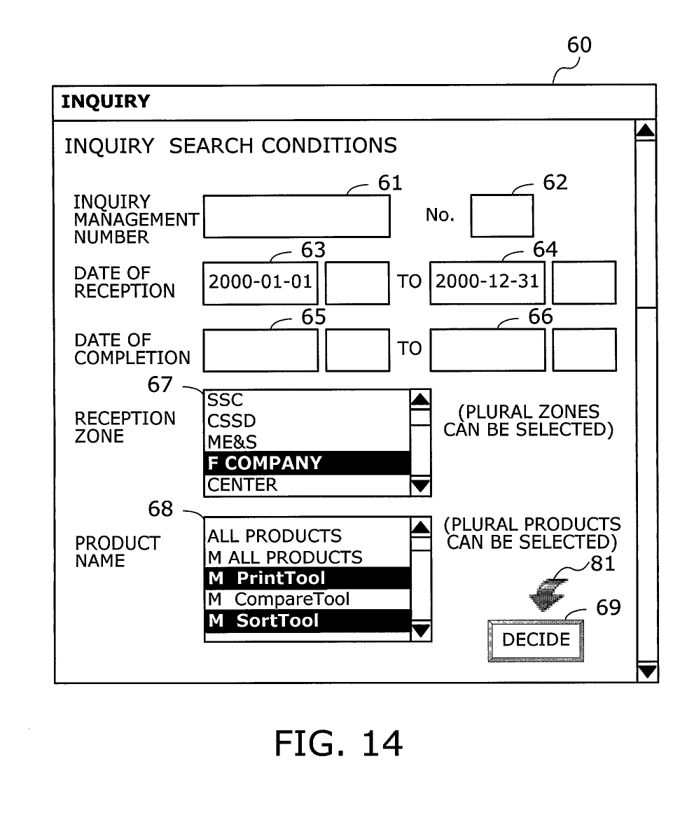

FIG. 14 shows a displayed view with an object to be operated on being visually clearly indicated. In FIG. 14, when the decision button 69 is to be pressed, the test rerunning unit 137 displays an arrow icon 81 pointing to the decision button 69. The arrow icon 81 is displayed for a given period of time. While the arrow icon 81 is being displayed, the pressing process of the decision button 69 is stopped. When the arrow icon 81 disappears, the rerunning process proceeds, and the decision button 69 is pressed.

Therefore, before the decision button 69 is pressed, the arrow icon 81 visually indicates in highlight to the test operator that the object to be operated on is the decision button 69.

If a button or a link to be operated on is outside of the view 60 in the WEB browser 120 and hence the view 60 needs to be scrolled, then the test rerunning unit 137 instructs the WEB browser 120 to scroll the view 60.

The display of the arrow icon 81 may be replaced with the blinking of a button or a link to be operated on for a given period of time.

Whether an object to be operated on is to be visually clearly indicated or not can be selected by the test operator by a m ode setting. If the test operator wants to rerun a test while visually confirming an object to be operated on in the view, then the object to be operated on is visually clearly indicated to allow the test operator to confirm operation details successively. If the test operator knows operation details and wants to acquire the results of a rerun test only, then the object to be operated on is not visually clearly indicated to quickly rerun the test without interruptions.

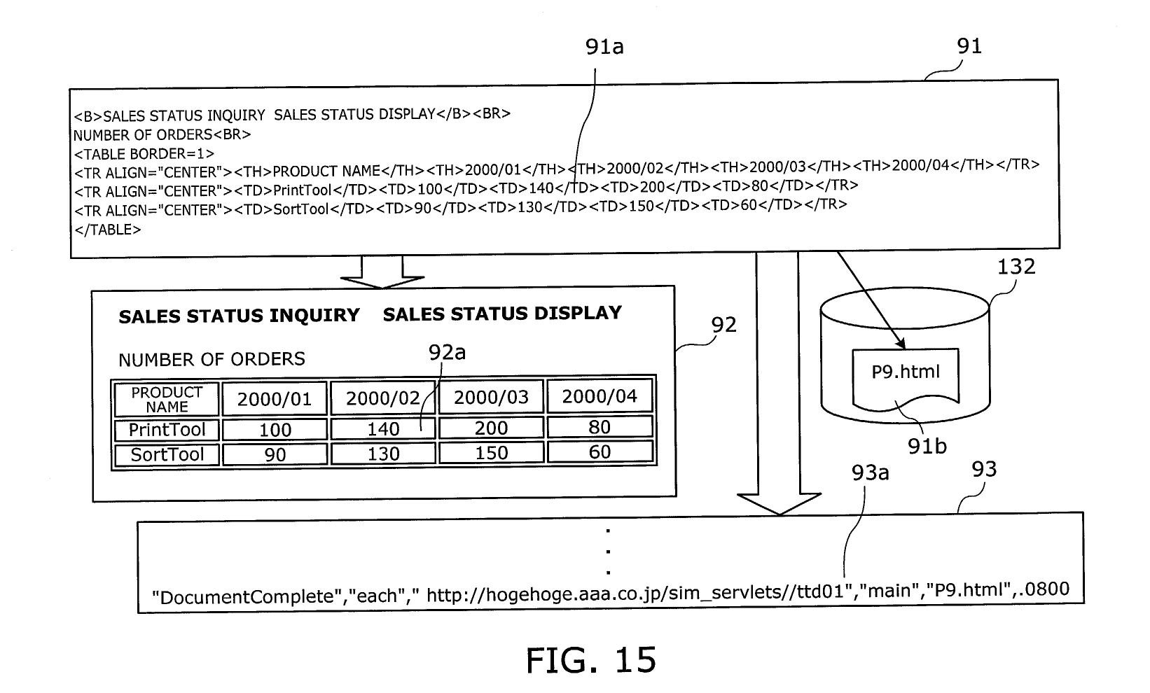

A comparing process will be described below with reference to FIGS. 15 through 17. In the comparing process, a test is rerun based on recorded results of the preceding test and the results of the rerun test are compared with the recorded results of the preceding test, and if there is a difference between the compared results, then the difference is pointed out and displayed to warn the test operator.

FIG. 15 shows results of a test which is run by operation inputs. After an execution request for performing a process of referring to a sales status from January 2000 to April 2000 is transmitted to the server application 31, the server application 31 returns the results of the executed process as shown in FIG. 15. The server application 31 sends a view file 91 in an HTML format representing a sales status to the WEB browser 120, which displays a view 92 representing the sales status on the display device 11a based on the view file 91.

When the view 92 is displayed, a view file 91b in an HTML format which is the same as the view file 91 is stored in the view file memory 132 by the test operation recorder 136. When the view file 91b is stored in the view file memory 132, a new file name “P9.html” is given to the view file 91b.

When the display of the view 92 is finished, the test operation recorder 136 stores a log file 93 in the log file memory 133. At this time, the log file 93 registers therein the URL of the view file 91, a frame name “main” and the file name “P9.html” of the saved view file 91b as an associated file 93a.

In the results of the test that has been run, “140” is set as a value 91a in February 2000 of product name “PrintTool”, for example, in the view file 91. In the view 92, therefore, “140” is displayed in a column 92a in February 2000 of product name “PrintTool”.

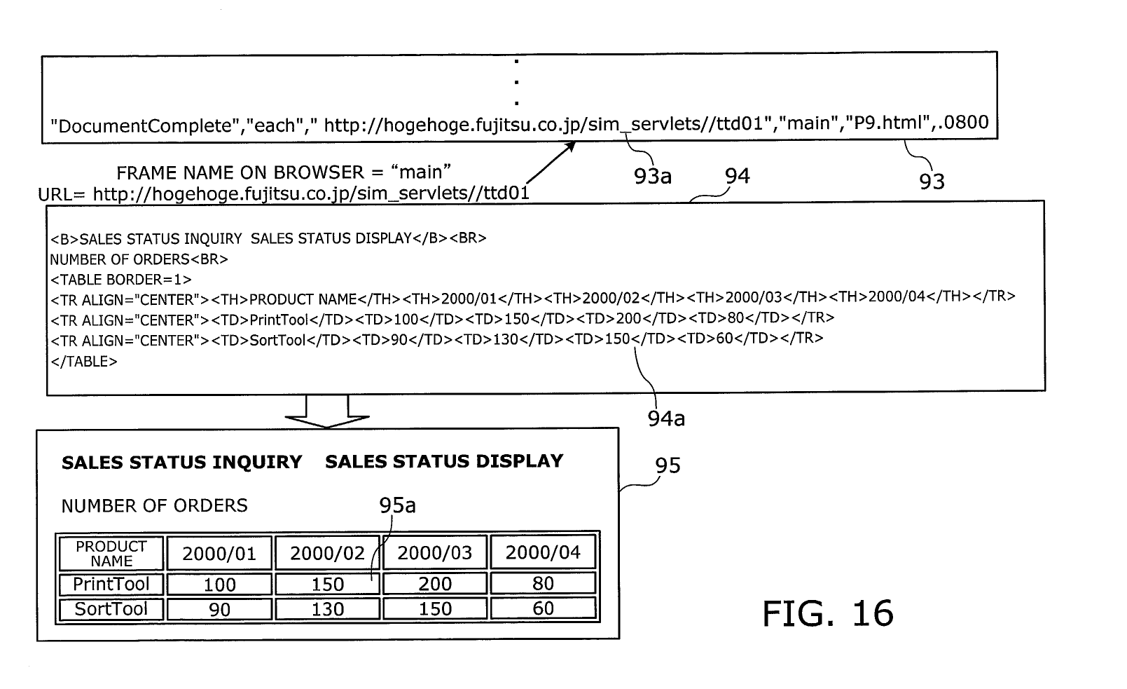

FIG. 16 shows the results of a test which is rerun. After a test is rerun based on the log file 93 which is generated when the results of the test shown in FIG. 15 are received, the server application 31 returns the results of the rerun test. The server application 31 transmits a view file 94 in an HTML format representing a sales status to the WEB browser 120, which displays a view 95 representing the sales status on the display device 11a based on the view file 94.

In the results of the test that has been rerun, “150” is set as a value 94a in February 2000 of product name “PrintTool”, for example, in the view file 94. In the view 95, therefore, “150” is displayed in a column 95a in February 2000 of product name “PrintTool”.

At this time, the test result comparing unit 138 compares the data in the view file 91b stored in the view file memory 132 and the data in the view file 94 shown in FIG. 16 with each other. The location of the view file 91 can be determined from the associated description 93a recorded in the log file 93. Specifically, when the WEB browser 120 changes displayed views and the URL and frame name recorded as the associated description 93a in the log file 93 and the URL and frame name of the displayed view agree with each other, the test result comparing unit 138 compares the saved view file 91b and the displayed view file 94 with each other.

As a result of the comparison between the view file 91b and the view file 94, the test result comparing unit 138 determines that the value in February 2000 of product name “PrintTool” has changed from “140” to “150”. Then, the test result comparing unit 138 displays the different data. For example, the test result comparing unit 138 changes data of the view file 94, displays the changed data in highlight, and allows the previous data to be displayed (tool tip display) when the mouse cursor is placed thereon.

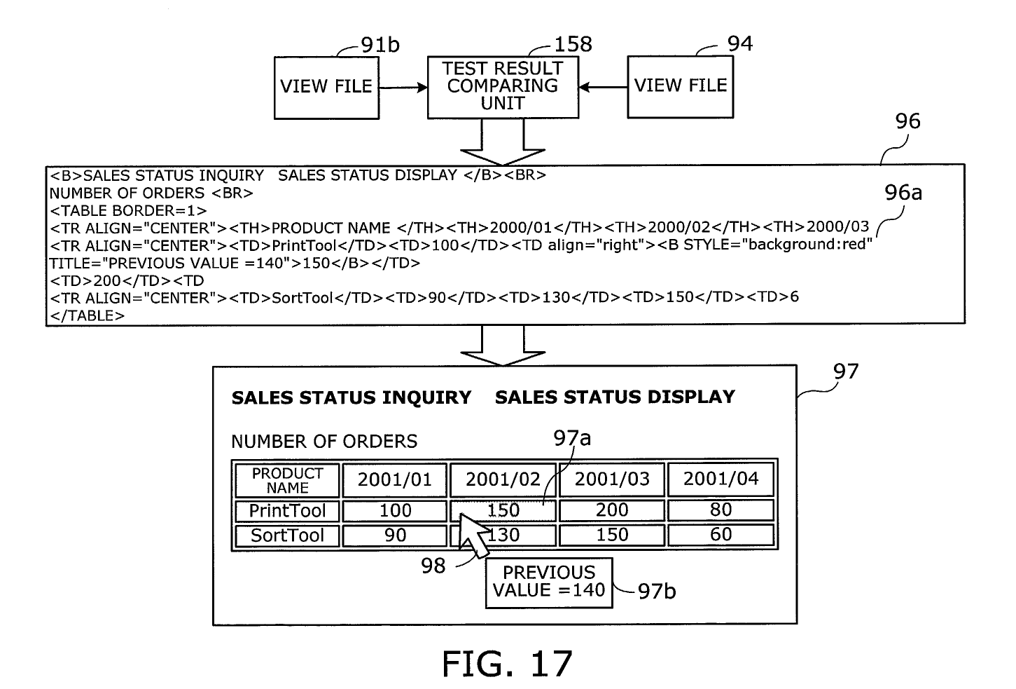

FIG. 17 shows the concept of a process of comparing test results. When the test result comparing unit 138 compares the view file 91b and the view file 94 with each other, the test result comparing unit 138 generates a view file 96 with the difference in highlight based on the view file 94. The view file 96 is transferred to the WEB browser 120, which displays a view 97 based on the view file 96 on the display device 11a.

In FIG. 17, the description <TD>150</TD> in the view file 94 is changed to a description 96a <TD align=“right”><B STYLE=“background:red” TITLE=“previous value=140”>150</B></TD>. Thus, the background of a column 97a whose data is different from the previous data in the view 97 is displayed in red. If the background of other columns is white, then the column 97a is highlighted. When a mouse cursor 98 is placed on the column 97a, a tool tip display area 97b appears, displaying the previous value therein.

A processing sequence of a process of rerunning a test will be described below.

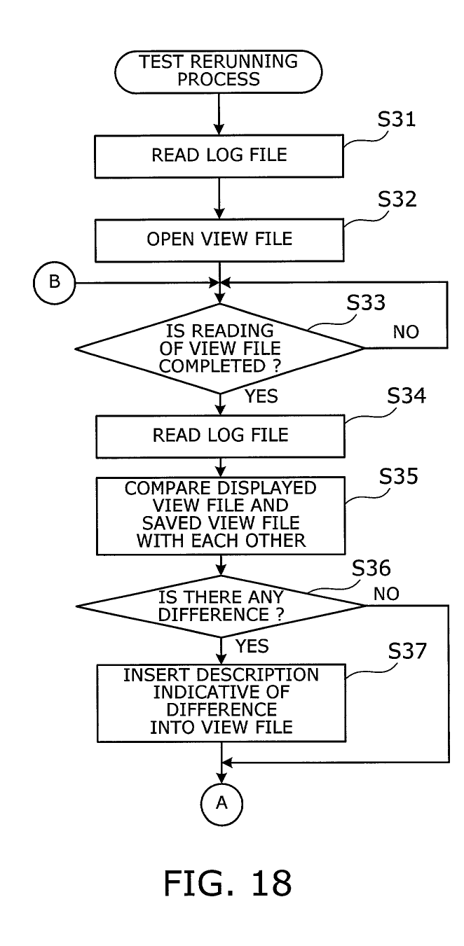

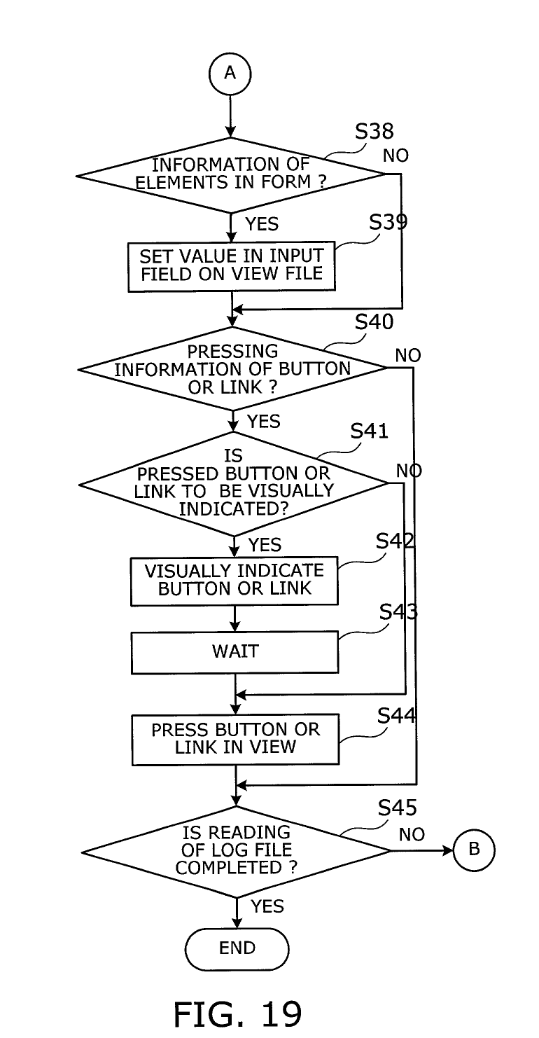

FIG. 18 shows a former portion of a processing sequence of a test rerunning process. The processing sequence shown in FIG. 18 will be described below according to step numbers shown therein.

[STEP S31] The test rerunning unit 137 reads a log file from the log file memory 133.

[STEP S32] The test rerunning unit 137 causes the WEB browser 120 to open a view file described at first in the read log file. The WEB browser 120 acquires a corresponding view file from the server application 31, and displays a view according to the view file.

[STEP S33] The test rerunning unit 137 determines whether the reading of the view file is completed or not. If the reading of the view file is completed, then control goes to step S34. If the reading of the view file is not completed, then the processing in step S33 is repeated.

[STEP S34] The test rerunning unit 137 reads descriptions following the description relative to the view file displayed in the log file successively line by line.

[STEP S35] The test result comparing unit 138 acquires a view file saved when the previous test was run, based on the associated description in the log file, and compares the displayed view file and the saved view file with each other.

[STEP S36] The test result comparing unit 138 determines whether there is any difference between the two compared view files or not. If there is any difference, then control goes to step S37. If there is no difference, then control goes to step S38 shown in FIG. 19.

[STEP S37] The test result comparing unit 138 inserts a description indicative of the difference between the view files into a view file read into the WEB browser 120.

FIG. 19 shows a latter portion of the processing sequence of the test rerunning process. The processing sequence shown in FIG. 19 will be described below according to step numbers shown therein.

[STEP S38] The test rerunning unit 137 determines whether the description of the read line in the log file is representative of information of elements in form. If it is representative of information of elements in form, then control goes to step S39. If it is not representative of information of elements in form, then control goes to step S40.

[STEP S39] The test rerunning unit 137 sets information indicated by the description read from the log file into the data input area in the view file.

[STEP S40] The test rerunning unit 137 determines whether the description of the read line in the log file is representative of pressing information of a button or a line or not. If the description of the read line in the log file is representative of pressing information, then control goes to step S41. If the description of the read line in the log file is not representative of pressing information, then control goes to step S45.

[STEP S41] The test rerunning unit 137 determines whether a pressing process of a button or a link is to be visually indicated or not, based on preset data entered by the test operator. If the pressing process is to be visually indicated, then control goes to step S42. If the pressing process is not to be visually indicated, then control goes to step S44.

[STEP S42] The test rerunning unit 137 visually indicates the pressing process of a button or a link. A button or a link is visually indicated by displaying an arrow icon pointing to an object to be operated on, or blinking an object to be operated on.

[STEP S43] The test rerunning unit 137 waits for a given period of time. After elapse of the given period of time, control goes to step S44.

[STEP S44] The test rerunning unit 137 instructs the WEB browser 120 to perform a pressing process of a button or a link in the displayed view.

[STEP S45] The test rerunning unit 137 determines whether the reading of the log file is completed or not. If there is a description not yet to be read in the log file, control goes back to step S33 shown in FIG. 18. If all the descriptions in the log file have been read, then the test rerunning process is put to an end.

When test operations are thus rerun according to the log file, a test which has been run once can automatically rerun for the updating of the version of the system and changes in the specifications of the system. Therefore, the efficiency of the test is increased. Since output view data are mechanically compared with each other when the test is rerun, undesirable mistakes in confirming the entered data are prevented.

[Response Measurement Assistance]

A response measurement assisting process will be described below. In the response measurement assisting process, a period of time consumed after a decision operation (such as the pressing of a button or a link) is made to change to another view (or maybe after a process execution request is issued to the server application 31) until execution results are returned, i.e., a period of time from the event of pressing a button in the view until the event of completing the reading from the view file of the execution results, is measured and displayed. The measured period of time is recorded in a log file.

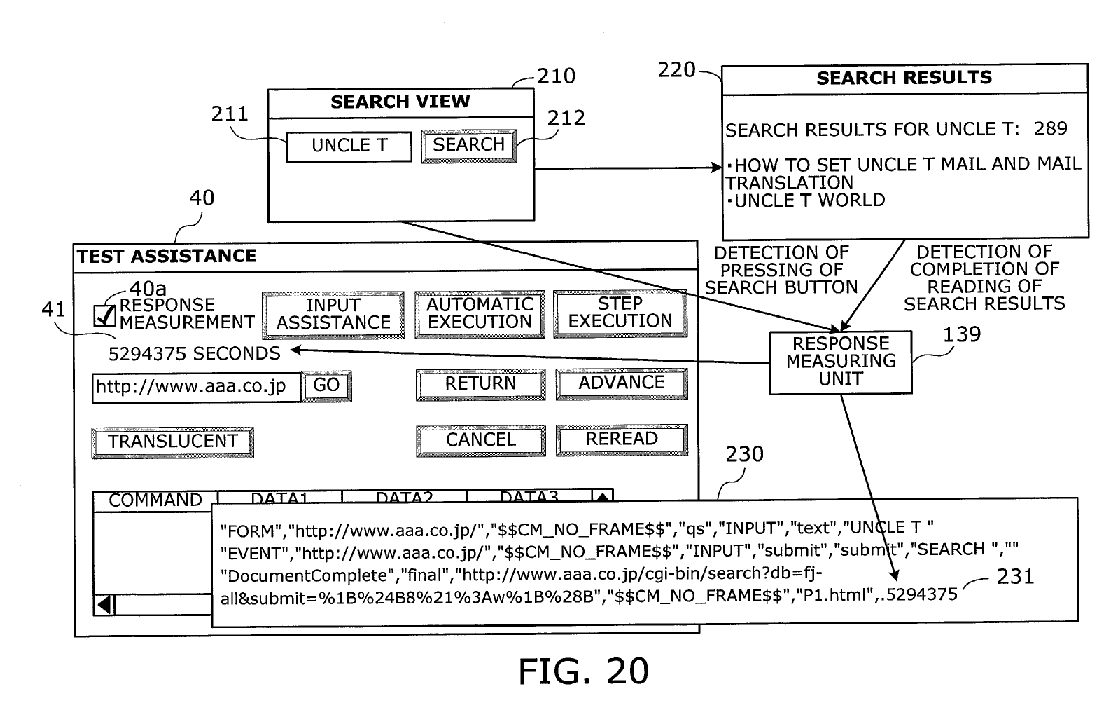

FIG. 20 shows the concept of the response measurement assisting process. In FIG. 20, a response at the time of carrying out a keyword search is measured. In a test assisting view 40, if the response measurement check box 40a is checked, then each time a process execution request is issued to the server application 31, the response measuring unit 139 measures a response.

For example, if “Uncle T” is entered into a data input area 211 for entering a search key in a search view 210 and a search button 212 is pressed, then the WEB browser 120 issues a search request to the server application 31. The response measuring unit 139 detects the operation input of the search button 212, and starts measuring time. Thereafter, the server application 31 conducts a search, and returns search results to the WEB browser 120. The response measuring unit 139 detects the completion of the reading of the search results by the WEB browser 120, and ends measuring time.

The response measuring unit 139 displays a measured response time 41 in the test assisting view 40, and resisters time information 231 representing the response time in a log file 230.

A processing sequence of a response measuring process will be described below.

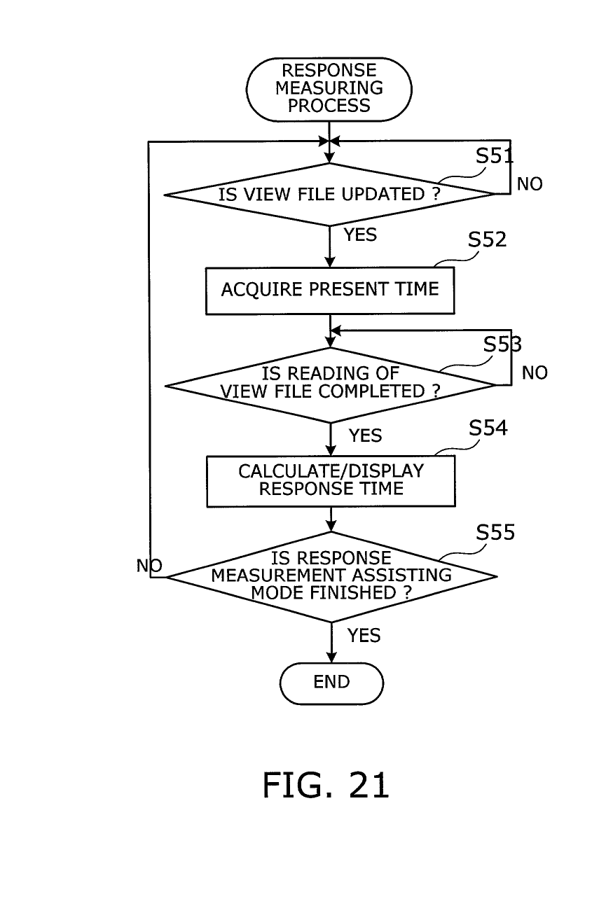

FIG. 21 shows a processing sequence of a response measuring process. The processing sequence shown in FIG. 21 will be described below according to step numbers shown therein. The response measuring process is executed while the response measurement check box 40a is being checked in the test assisting view 40.

[STEP S51] The response measuring unit 139 determines whether a view file is updated or not. A view file is updated when a request for acquiring another view file is transmitted from the WEB browser 120 to the server application 31 by pressing a button or a link. If a view file is updated, then control goes to step S52. If a view file is not updated, then the processing in step S51 is repeated.

[STEP S52] The response measuring unit 139 acquires a preset time.

[STEP S53] The response measuring unit 139 determines whether the reading of a view file, which is a response from the server application 31, by the WEB browser 120 is completed or not. If the reading of a view file is completed, then control goes to step S54. If the reading of a view file is not completed, then the processing in step S53 is repeated.

[STEP S54] The response measuring unit 139 calculates a response time from the time acquired in step S52 to the completion of the reading of the view file. The calculated response time is displayed in the test assisting view 40, and time information representing the response time is set in the log file.

[STEP S55] The response measuring unit 139 determines whether the response measurement assisting mode is finished or not. The response measurement assisting mode is finished by unchecking the response measurement check box 40a. If the response measurement assisting mode is not finished, control goes back to step S51. If the response measurement assisting mode is finished, then the response measuring process is ended.

In this manner, the response time can automatically be measured and recorded. Heretofore, the response time has been measured by the test operator using a stopwatch. The response measurement assisting function according to the present invention reduces the burden on the test operator because the response measuring process is automatized. Since the response time is mechanically measured, the response time can be measured accurately.

[Making Translucent a Test Assisting View]

A process of rendering a test assisting view translucent will be described below. If a test assisting view and a WEB browser view are superposed on each other when a test is rerun, the WEB browser view cannot clearly be seen. To avoid the visibility problem of the WEB browser view, according to the present invention, the test assisting view is rendered translucent to allow the test operator to easily confirm the displayed data in the browser view and operate on the test assister.

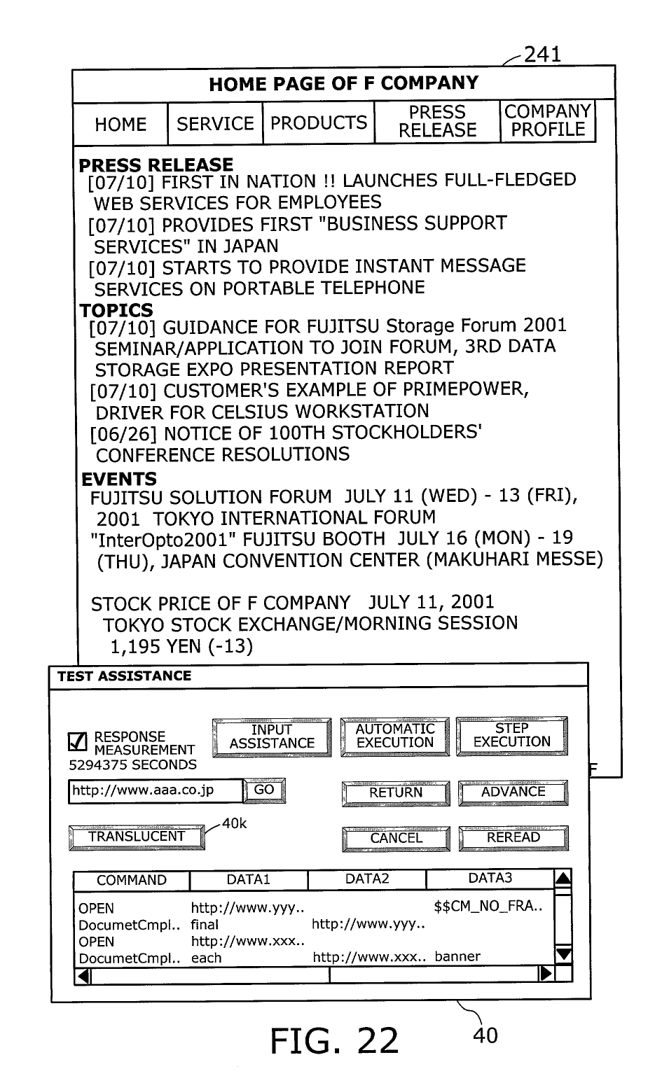

FIG. 22 shows a test assisting view before it is rendered translucent. In FIG. 22, a test assisting view 40 is displayed in superposed relation to a WEB browser view 241. If the test assisting view 40 and the WEB browser relation to each other due to the size limitation of the screen of the display device 11a, the test operator presses a translucent button 40k for making the test assisting view 40 translucent.

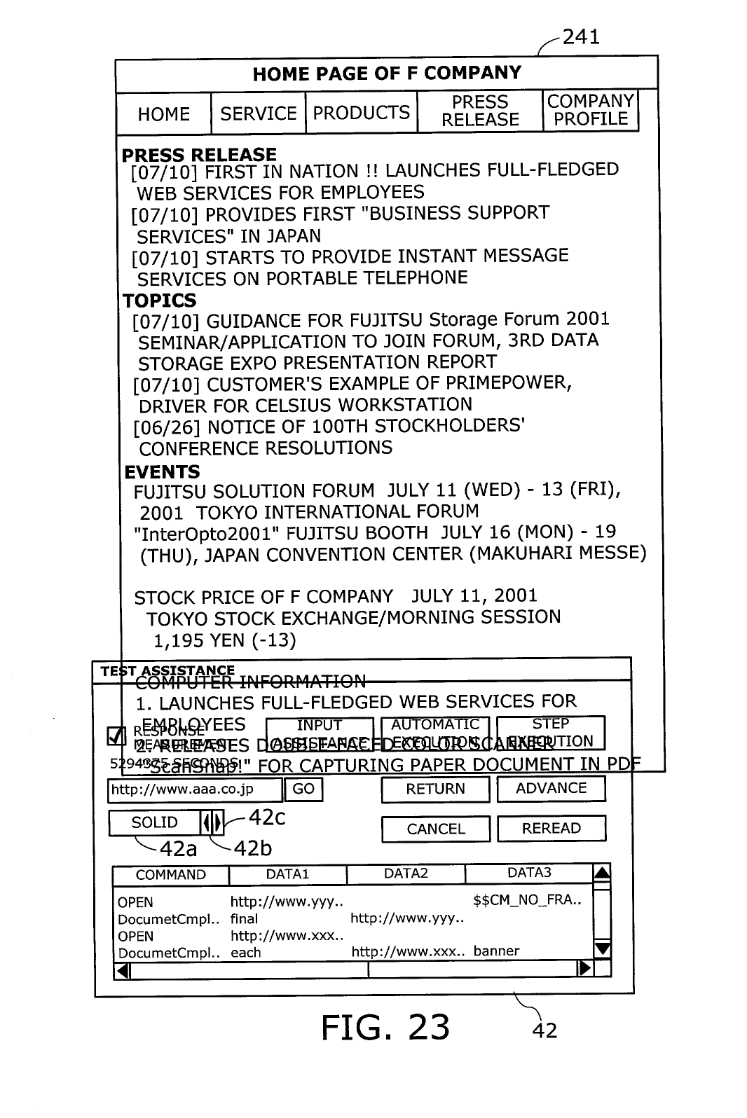

FIG. 23 shows the test assisting view after it is rendered translucent. In FIG. 23, a test assisting view 42 which is rendered translucent has a solid button 42a, a transparency reducing button 42b, and a transparency increasing button 42c instead of the translucent button 40k.

The solid button 42a is a button for making the test assisting view 42 solid, i.e., non-translucent. When the solid button 42a is pressed, the translucent test assisting view 42 changes to the test assisting view 40 before it is made translucent.

The transparency reducing button 42b is a button for reducing the transparency of the test assisting view 42. When the transparency reducing button 42b is pressed, the transparency of the test assisting view 42 is reduced. When the transparency of the test assisting view 42 is reduced, the brightness of an image representing the test assisting view 42 is increased, and the brightness of an image hidden by the test assisting view 42 is lowered.

The transparency increasing button 42c is a button for increasing the transparency of the test assisting view 42. When the transparency increasing button 42c is pressed, the transparency of the test assisting view 42 is increased. When the transparency of the test assisting view 42 is increased, the brightness of an image representing the test assisting view 42 is lowered, and the brightness of an image hidden by the test assisting view 42 is increased.

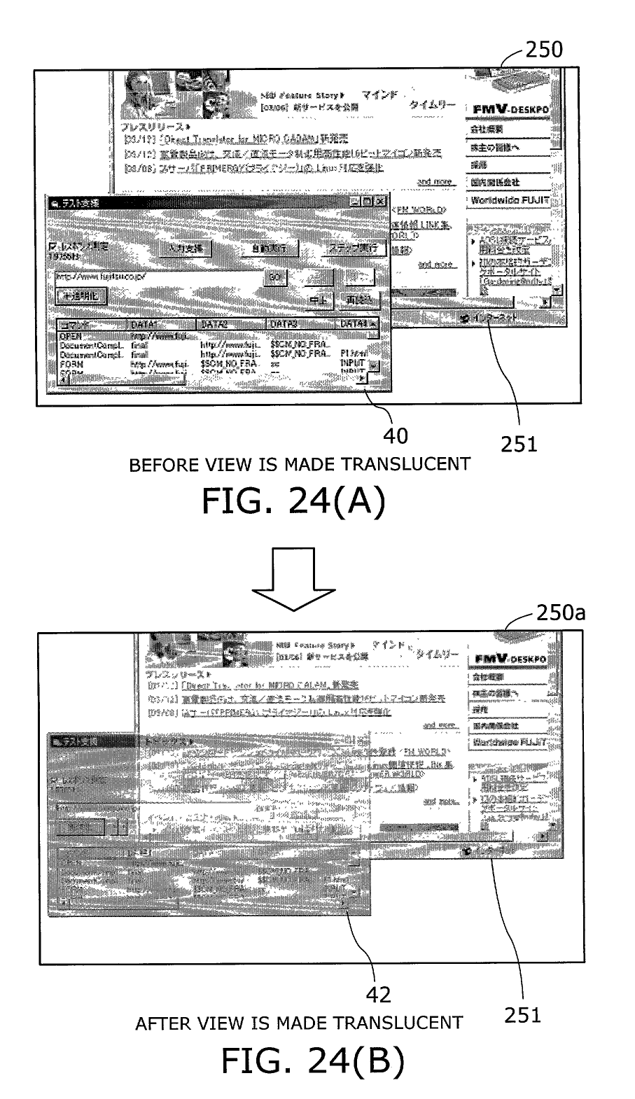

FIGS. 24(A) and 24(B) show an image change caused by rendering the test assisting view translucent, FIG. 24(A) showing an image before it is rendered translucent and FIG. 24(B) showing an image after it is rendered translucent.

An image 250 before it is made translucent comprises a WEB browser 251 and the test assisting view 40 superposed thereon, with a lower left portion of the WEB browser 251 being concealed from view.

An image 250a after it is made translucent comprises the WEB browser 251 and the translucent test assisting view 42 superposed thereon. Since the test assisting view 42 is translucent, the lower left portion of the WEB browser 251 can be visually recognized.

A process of making the test assisting view translucent will be described below.

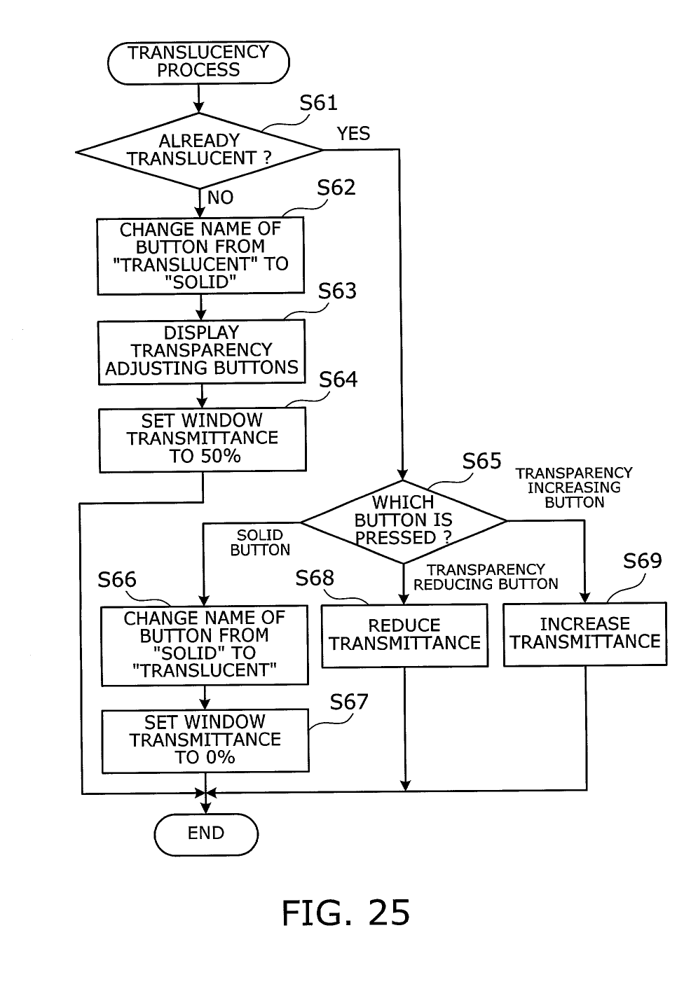

FIG. 25 shows a processing sequence of a process of making the test assisting view translucent. The processing sequence shown in FIG. 25 will be described below according to step numbers shown therein. The processing sequence described below is executed when either one of the translucent button 40k, the solid button 42a, the transparency reducing button 42b, and the transparency increasing button 42c is pressed.

[STEP S61] The user interface 134 determines whether the test assisting view has already been translucent or not. If the test assisting view has already been translucent, then control goes to step S65. If the test assisting view has not been translucent, then control goes to step S62.

[STEP S62] The user interface 134 changes the name of the translucent button 40k from “TRANSLUCENT” to “SOLID”, thus changing the button from the translucent button 40k to the solid button 42a.

[STEP S63] The user interface 134 displays transparency adjusting buttons, i.e., transparency reducing button 42b and the transparency increasing button 42c, in the test assisting view.

[STEP S64] The user interface 134 sets the window transmittance of the test assisting view to 50%, thus making the test assisting view translucent. Thereafter, the process of making the test assisting view translucent is put to an end.

[STEP S65] If the test assisting view has already been translucent, then the user interface 134 determines which button has been pressed. If the solid button 42a has been pressed, control goes to step S66. If the transparency reducing button 42b is pressed, then control goes to step S68. If the transparency increasing button 42c is pressed, then control goes to step S69.

[STEP S66] The user interface 134 changes the name of the solid button 42a from “SOLID” to “TARNSLUCENT”, changing the button from the solid button 42a to the translucent button 40k.

[STEP S67] The user interface 134 sets the window transmittance of the test assisting view to 0%, thus making the test assisting view opaque. Thereafter, the process of making the test assisting view translucent is put to an end.

[STEP S68] The user interface 134 reduces the window transmittance of the test assisting view, thus reducing the transparency of the test assisting view.

[STEP S69] The user interface 134 increases the window transmittance of the test assisting view, thus increasing the transparency of the test assisting view.

The transparency of the test assisting view can thus be changed as desired in the manner described above. Therefore, even when the image of an object to be tested is displayed fully in the screen of the display monitor, the image of the object can be seen through the test assisting view by the translucency function, making it possible to perform the test efficiently.

The above processing functions can be performed by a computer. If the processing functions are performed by a computer, then there is provided a program which describes the processing details of the functions which the test assister should have, and the program is run by the computer to perform the above processing functions. The program which describes the processing details of the functions can be recorded in a recording medium which can be read by the computer. A computer-readable recording medium may be a magnetic recording device, an optical disk, a magneto-optical recording medium, a semiconductor memory, or the like. The magnetic recording device may be a hard disk drive(HDD), a flexible disk(FD), a magnetic tape, or the like. The optical disk may be a DVD(Digital Versatile Disk), a DVD-RAM(Random Access Memory), a CD-ROM (Compact Disc Read Only Memory), a CD-R (Recordable)/RW(ReWritable), or the like. The magneto-optical recording medium may be a MO(magneto-optical) disk.

To distribute the program, portable recording mediums such as DVDs, CD-ROMs, etc. in which the program is recorded are offered for sale. The program may be stored in a memory of a server computer, and transferred from the server computer via a network to another computer.

The computer which runs the program stores the program recorded the portable recording medium or transferred from the server computer into its own memory. Then, the computer reads the program from its own memory, and runs the program to perform processes according to the program. The computer may read the program directly from the portable recording medium and run the program to perform processes according to the program. Alternatively, each time a program is transferred from the server computer, the computer may perform a process according to the received program.

In the first through third aspects of the present invention, since candidate data depending on the attribute of a data input area are generated and candidate data selected by an operation input is set in the data input area, errors in entering the data can be reduced, and the reliability of test results can be increased.

According to the second aspect of the present invention, the details of operation inputs are recorded as a log file, and operation inputs are reproduced according to the recorded details of the log file. Therefore, the operation details in a past test can be reproduced accurately to perform the same test, and hence the reliability of test results can be increased.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A test assisting program for assisting in testing operation of a server computer which provides services using a structured document which can be browsed by a document browsing device, the test assisting program enabling a computer to carry out a process comprising steps of:
acquiring attribute information of a data input area of the structured document upon reception of the structured document from the server computer;
generating candidate data for data to be inputted into the data input area based on the attribute information of the data input area;
inserting a processing description for enabling the document browsing device to carry out a process of displaying the candidate data and a process of entering the candidate data selected by an operation input into the data input area, in the structured document; and
transferring the structured document with the processing description inserted therein to the document browsing device.

2. The test assisting program according to claim 1, wherein the step of generating the candidate data comprises a step of generating data matching the attribute information and data not matching the attribute information.

3. A test assisting program for assisting in testing operation of a server computer which provides services using a structured document which can be browsed by a document browsing device, the test assisting program enabling a computer to carry out a process comprising steps of:
determining details of an operation input for requesting the server computer to carry out a process when the operation input is applied to the document browsing device;
generating a log file in which the determined details of the operation input are recorded; and
reproducing the operation input applied to the document browsing device according to the details of the operation input which are recorded in the log file.

4. The test assisting program according to claim 3, wherein an object to be operated on is displayed in highlight for a predetermined period of time when the operation input is reproduced.

5. The test assisting program according to claim 4, wherein the operation input is prevented from being reproduced until the display in highlight of the object to be operated on is finished.

6. The test assisting program according to claim 3, wherein when a process result is returned from the server computer due to the reproduced operation input, the test assisting program enables the computer to compare the process result and a past process result returned from the server computer due to the operation input, and display a difference between the compared process results.

7. The test assisting program according to claim 3, wherein the test assisting program enables the computer to measure a time from a decision in the operation input for requesting the server computer to carry out the process until a process result is returned from the server computer, and display the measured time.

8. The test assisting program according to claim 3, wherein the test assisting program enables the computer to render translucent an operation view for entering the operation input and display the translucent operation view.

9. A test assisting method in a test assisting apparatus for assisting in testing operation of a server computer which provides services using a structured document which can be browsed by a document browsing device, comprising steps of:
acquiring attribute information of a data input area of the structured document upon reception of the structured document from the server computer;
generating candidate data for data to be inputted into the data input area based on the attribute information of the data input area;
inserting a processing description for enabling the document browsing device to carry out a process of displaying the candidate data and a process of entering the candidate data selected by an operation input into the data input area, in the structured document; and
transferring the structured document with the processing description inserted therein to the document browsing device.

10. A test assisting method in a test assisting apparatus for assisting in testing operation of a server computer which provides services using a structured document which can be browsed by a document browsing device, comprising steps of:
determining details of an operation input for requesting the server computer to carry out a process when the operation input is applied to the document browsing device;
generating a log file in which the determined details of the operation input are recorded; and
reproducing the operation input applied to the document browsing device according to the details of the operation input which are recorded in the log file.

11. A test assisting apparatus for assisting in testing operation of a server computer which provides services using a structured document which can be browsed by a document browsing device, comprising:
acquiring means for acquiring attribute information of a data input area of the structured document upon reception of the structured document from the server computer;
generating means for generating candidate data for data to be inputted into the data input area based on the attribute information of the data input area acquired by the acquiring means;
inserting means for inserting a processing description for enabling the document browsing device to carry out a process of displaying the candidate data generated by the generating means and a process of entering the candidate data selected by an operation input into the data input area, in the structured document; and
transferring means for transferring the structured document with the processing description inserted therein by the inserting means to the document browsing device.

12. A test assisting apparatus for assisting in testing operation of a server computer which provides services using a structured document which can be browsed by a document browsing device, comprising:
determining means for determining details of an operation input for requesting the server computer to carry out a process when the operation input is applied to the document browsing device;
generating means for generating a log file in which the determined details of the operation input are recorded; and
reproducing means for reproducing the operation input applied to the document browsing device according to the details of the operation input which are recorded in the log file.

13. A recording medium readable by a computer and storing a test assisting program for assisting in testing operation of a server computer which provides services using a structured document which can be browsed by a document browsing device, the test assisting program enabling a computer to carry out a process comprising steps of:
acquiring attribute information of a data input area of the structured document upon reception of the structured document from the server computer;
generating candidate data for data to be inputted into the data input area based on the attribute information of the data input area;
inserting a processing description for enabling the document browsing device to carry out a process of displaying the candidate data and a process of entering the candidate data selected by an operation input into the data input area, in the structured document; and
transferring the structured document with the processing description inserted therein to the document browsing device.

14. A recording medium readable by a computer and storing a test assisting program for assisting in testing operation of a server computer which provides services using a structured document which can be browsed by a document browsing device, the test assisting program enabling a computer to carry out a process comprising steps of:
determining details of an operation input for requesting the server computer to carry out a process when the operation input is applied to the document browsing device;
generating a log file in which the determined details of the operation input are recorded; and
reproducing the operation input applied to the document browsing device according to the details of the operation input which are recorded in the log file.
